(19) United States
(12) Patent Application Publication
(10) Pub. No.: US 2017/0215419 A1
(43) Pub. Date: Aug. 3, 2017

(54) ANTHRANILAMIDE SEED TREATMENT COMPOSITIONS AND METHODS OF USE

(71) Applicants: PIONEER HI-BRED INTERNATIONAL, INC., Johnston, IA (US); E I DU PONT DE NEMOURS AND COMPANY, Wilmington, DE (US)

(72) Inventors: MARCO TOAPANTA, Parkville, MO (US); KEITH O'BRYAN, Johnston, IA (US); MICHAEL RUPERT, LONG BEACH, CA (US); MARC TREURNIET, SOUTHPORT, NC (US)

(21) Appl. No.: 15/328,287

(22) PCT Filed: Jul. 29, 2015
(86) PCT No.: PCT/US15/42651

§ 371 Date: Jan. 23, 2017

Related U.S. Application Data
(60) Provisional application No. 62/031,525, filed on Jul. 31, 2014.

(51) Int. Cl. A01N 43/56

(52) U.S. Cl. CPC A01N 43/56

(57) ABSTRACT

Disclosed are methods of increasing crop yields as well as reducing pest damage to crop plants through anthranilamide seed treatment compositions. Chlorantraniliprole combinations with other insecticides, fungicides, nematicides and biological components are disclosed. Cyantraniliprole combinations with other insecticides, fungicides, nematicides and biological components are disclosed.

### CROSS REFERENCE TO RELATED APPLICATIONS

This application claims priority to U.S. Ser. No. 62/031,525, filed Jul. 31, 2014, the contents of which are hereby incorporated by reference.

### FIELD

This disclosure relates to methods of increasing crop yields and pest control.

### BACKGROUND

The control of invertebrate pests is extremely important in achieving high crop efficiency. Damage by invertebrate pests to growing and stored agronomic crops can cause significant reduction in productivity and thereby result in increased costs to the consumer. The control of invertebrate pests in forestry, greenhouse crops, ornamentals, nursery crops, stored food and fiber products, livestock, household, turf, wood products, and public and animal health is also important. Many products are commercially available for these purposes and in practice have been used as a single or a mixed agent. However, more economically efficient and ecologically safe pest control compositions and methods are still being sought.

### SUMMARY

This disclosure pertains to a method for increasing crop growth, yield or vigor comprising treatment of crop plants in an area under cultivation with an effective amount of a carboxamide arthropodicide, its N-oxide, or a salt thereof.

Seeds treated with a seed treatment composition comprising an effective amount of chlorantraniliprole in combination with an insecticide thiamethoxam or clothianidin; a fungicide selected from the group consisting of azoxystrobin, fludioxonil, mefenoxam, thiabendazole, Tebuconazol, penthiopyrad, and oxathiapiprolin; and a seed treatment component selected from the group consisting of Bacillus firmus 1-1582, Bacillus subtilis, and Bacillus simplex are disclosed. In an embodiment, the seed is a maize seed. In an embodiment, the maize seed includes a recombinant nucleotide sequence encoding or expressing an insecticidal protein selected from the group consisting of Cry1Ab, Cry1F, Cry34/35, Vip3A, mCry3A, cry2A.127, cry1A.88, and Vip3Aa20. In an embodiment, the treated seed includes a transgenic trait. In an embodiment, the treated seed includes a non-transgenic trait or native trait providing tolerance to one or more pests or disease or drought. In an embodiment, the treated seed includes a recombinant nucleotide expressing a dsRNA capable of downregulating an essential endogenous gene of a pest.

In an embodiment, a seed treated with a seed treatment composition comprising an effective amount of chlorantraniliprole in combination with an insecticide thiamethoxam, clothianidin or imidacloprid, a fungicide selected from the group consisting of metalaxyl, trifloxystrobin, penthiopyrad, oxathiapiprolin, sedaxane, penflufen, prothioconazole, difenoconazole, and fluopyram; and a seed treatment component selected from the group consisting of Bradyrhizobium japonicum, Bacillus firmus 1-1582, Bacillus subtilis, Bacillus simplex, and Pasteuria nishizawae. In an embodiment, the seed is a soybean seed. In an embodiment, the soybean seed includes a recombinant nucleotide sequence encoding an insecticidal protein. In an embodiment, the soybean seed includes a transgenic trait. In an embodiment, the soybean seed includes a non-transgenic trait providing tolerance to one or more pests or disease. In an embodiment, the soybean seed comprising the non-transgenic trait exhibits tolerance to one or more of sudden death syndrome (SDS), soybean cyst nematode (SCN), phytophthora, and pythium.

In an embodiment, seeds treated with a seed treatment composition comprising an effective amount of chlorantraniliprole in combination with an insecticide thiamethoxam, clothianidin or imidacloprid, a fungicide selected from the group consisting of metalaxyl, picoxystrobin, penthiopyrad, difenoconazole, trifloxystrobin, penflufen, fludioxonil; and a seed treatment component Penicillium bilaii are disclosed. In an embodiment, the seed is canola seed.

A method of reducing wireworm damage to plants includes growing a plant seed treated with chlorantraniliprole in combination with an insecticide thiamethoxam or clothianidin; a fungicide selected from the group consisting of azoxystrobin, fludioxonil, mefenoxam, thiabendazole, tebuconazol, penthiopyrad, and oxathiapiprolin; and a seed treatment component selected from the group consisting of Bacillus firmus 1-1582, Bacillus subtilis, and Bacillus simplex. In an embodiment, the plant is grown in a crop growing environment suspected of containing wireworms.

In an embodiment, methods of reducing cutworm damage to plants, the method comprising growing a plant seed treated with chlorantraniliprole in combination with an insecticide thiamethoxam or clothianidin; a fungicide selected from the group consisting of azoxystrobin, fludioxonil, mefenoxam, thiabendazole, tebuconazol, penthiopyrad, and oxathiapiprolin; and a seed treatment component selected from the group consisting of Bacillus firmus 1-1582, Bacillus subtilis, and Bacillus simplex are disclosed.

In an embodiment, methods of reducing insect damage to plants that include:

(a) growing a plant seed treated with a reduced amount (for example lower than the labeled rate or amount) of one or more neonicotinoid insecticides and in combination with an effective amount of chlorantraniliprole; and

(b) reducing the extent of insect damage on the plants.

In an embodiment, the amount of neonicotinoid insecticide is reduced by about 10%, 20%, 30%, 40%, 50%, 60%, 70%, 80% or 90% than the amount typically required to reduce the extent of damage to the plants.

In an embodiment, methods of reducing dust-off of seeds treated with chlorantraniliprole or cyantraniliprole include coating the seed with a dust-reducing agent and chlorantraniliprole or cyantraniliprole, whereby the reducing agent improves lubricity in a planter and also minimizes dust emission. In an embodiment, the dust-reducing agent is a polyethylene wax. In an embodiment, the seed includes a dust-reducing agent applied to the surface of the seed. In an embodiment, the dust-reducing agent is applied during or prior to planting.

In an embodiment, methods of reducing seed-corn maggot damage to plants, the method comprising growing a plant seed treated with chlorantraniliprole in combination with an insecticide thiamethoxam or clothianidin; a fungicide selected from the group consisting of azoxystrobin, fludioxonil, mefenoxam, thiabendazole, tebuconazol, penthiopyrad, and oxathiapiprolin; and a seed treatment component selected from the group consisting of Bacillus firmus 1-1582, Bacillus subtilis, and Bacillus simplex are disclosed.

### BRIEF DESCRIPTION OF THE DRAWINGS

FIG. 1 shows efficacy of chlorantraniliprole against wireworm (30 DAP) and impact on corn yield based on data from 4 Locations. Unless indicated otherwise, “BASE ST” included Fludioxonil, Mefenoxam, Azoxystrobin, Thiabendazole (fungicides), Thiamethoxam (insecticide) and biological amendments (B. subtilis, and B. simplex). The BASE ST may also include other fungicides.

FIG. 2 shows efficacy of chlorantraniliprole against high wireworm pressure locations for plant vigor and yield (A) and stand protection (B). “FST” indicates fungicide seed treatment.

FIG. 3 shows efficacy of chlorantraniliprole against white grub (30 DAP) and impact on corn yield based on data from 3 locations.

FIG. 4 shows efficacy of chlorantraniliprole against white grub (Japanese Beetle larvae).

FIG. 5 shows efficacy of chlorantraniliprole against high pressure of black cutworms, and plant stand protection (15 DAP). Damage Scale: 0 to 3, where 0=no damage, 1=moderate feeding, 2=heavy feeding, 3=cut plant.

FIG. 6 shows efficacy of chlorantraniliprole for healthier stand and longer seedling protection against black cutworms (9 DAI).

FIG. 7 shows efficacy of chlorantraniliprole against seed corn maggot (20DAP).

FIG. 8 shows yield impact of for corn treated with chlorantraniliprole based on all tested locations (total=64) and those locations with insect pressure (responsive locations=33) in the trial.

FIG. 9 shows effects of various insecticide seed treatments on corn plant weight. Untreated Check (UTX); chlorantraniliprole (LUM); thiamethoxam (IST), PV (clothianidin-B. firmus); fungicide seed treatment (FST); wireworm (WW). The numbers on the x-axis indicate μg AI/seed. Corn plants were at V3-V4 when the fresh plant weight (g) was measured.

### DETAILED DESCRIPTION

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “arthropod pest” includes insects, mites and ticks that are pests of growing or stored agronomic crops, forestry, greenhouse crops, ornamentals, nursery crops, stored food or fiber products, livestock, houses and other buildings or injurious to public and animal health.

The term “LC₅₀” or “LD₅₀” refers to the concentration or dose of a pesticide which when applied to the target pest species will result in 50% mortality. The term “sub-lethal concentration”, “sub-lethal dose” or “sub-lethal amount”, by this definition, means a concentration or dose causing about 50% or less mortality (<LC₅₀ or LD₅₀); in other words, at least about 50% of the population are alive at one day (24 hours) after treatment application.

The term “infectious disease” refers to diseases of plants or animals caused by infectious agents including viruses, bacteria, fungi, mycoplasma and phytoplasma.

The term “infectious plant diseases” refers to diseases, which reduce crop vigor or crop yield, which are caused by plant infectious agents including viruses, bacteria, fungi and phytoplasma.

The term “disrupting disease transmission” refers to an impairment of a population of arthropod pests (relative to a population of untreated arthropod pests) to act as vectors for infectious diseases.

The term “disrupting plant disease transmission” refers to an impairment of a population of arthropod pests (relative to a population of untreated arthropod pests) to act as vectors for infectious plant diseases.

The terms “disrupting amount” and “disruptive amount” as used herein refer to an amount of compound effective to disrupt transmission of infectious disease (for example, an infectious plant disease) by an arthropod pest.

The term “effective amount” as used herein as it relates to crop yield or crop vigor refers to an amount of compound effective to increase crop yield or crop vigor.

“Crop yield” as defined herein refers to the return of crop material obtained after harvesting a plant crop. An increase in crop yield refers to an increase in crop yield relative to an untreated control crop.

“Crop vigor” refers to rate of growth or biomass accumulation of a crop plant. An “increase in vigor refers” to an increase in growth or biomass accumulation in crop plants relative to an untreated control crop.

As referred to in the present disclosure and claims, the term “propagule” means a seed or a regenerable plant part. The term “regenerable plant part” means a part of a plant other than a seed from which a whole plant may be grown or regenerated when the plant part is placed in horticultural or agricultural growing media such as moistened soil, peat moss, sand, vermiculite, perlite, rock wool, fiberglass, coconut husk fiber, tree fern fiber and the like, or even a completely liquid medium such as water. Regenerable plant parts commonly include rhizomes, tubers, bulbs and corms of such geophytic plant species as potato, sweet potato, yam, onion, dahlia, tulip, narcissus, etc. Regenerable plant parts include plant parts that are divided (e.g., cut) to preserve their ability to grow into a new plant. Therefore regenerable plant parts include viable divisions of rhizomes, tubers, bulbs and corms which retain meristematic tissue, such as an eye. Regenerable plant parts can also include other plant parts such as cut or separated stems and leaves from which some species of plants can be grown using horticultural or agricultural growing media. As referred to in the present disclosure and claims, unless otherwise indicated, the term “seed” includes both unsprouted seeds and sprouted seeds in which the testa (seed coat) still surrounds part of the emerging shoot and root.

As is well known in the art, the term “carboxamide” refers to a moiety comprising a carbon, nitrogen and oxygen atom bonded in the configuration shown as Formula A. The carbon atom in Formula A is bonded to a carbon atom in a radical to which the carboxamide moiety is bonded. The nitrogen atom in Formula A is bonded to the carbonyl carbon of Formula A and also bonded to two other atoms, at least one atom of which is selected from a hydrogen atom or a carbon atom of another radical to which the carboxamide moiety is bonded.

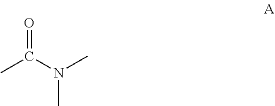

In one embodiment the carboxamide arthropodicide of the present method contains at least two carboxamide moieties. In another embodiment the carboxamide arthropodicide contains at least two carboxamide moieties vicinally bonded to carbon atoms (i.e. in ortho arrangement) of a carbocyclic or heterocyclic ring. In a further embodiment the carbocyclic or heterocyclic ring of the at least one carboxamide arthropodicide is aromatic (i.e. satisfies the Hückel 4n+2 rule for aromaticity).

Embodiments of the present disclosure include:

### Embodiment 1

The methods described in the Summary of the Disclosure wherein the carboxamide arthropodicide is selected from an anthranilamide (also described as anthranilic diamide) of Formula 1, an N-oxide, or a salt thereof,

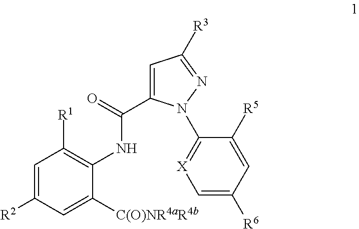

wherein

X is N, CF, CCl, CBr or Cl;

R¹ is CH₃, Cl, Br or F;

R² is H, F, Cl, Br or CN;

R³ is F, Cl, Br, C₁-C₄ haloalkyl or C₁-C₄ haloalkoxy;

R^{4a} is H, C₁-C₄ alkyl, cyclopropylmethyl or 1-cyclopropylethyl;

R^{4b} is H or CH₃;

R⁵ is H, F, Cl or Br; and

R⁶ is H, F, Cl or Br.

### Embodiment 1A

The methods of Embodiment 1 wherein X is N; R¹ is CH₃; R² is Cl or CN; R³ is Cl, Br or CF₃; R^{4a} is C₁-C₄ alkyl; R^{4b} is H; R⁵ is Cl; and R⁶ is H.

### Embodiment 1B

The methods of Embodiment 1 wherein X is N; R¹ is CH₃; R² is Cl or CN; R³ is Cl, Br or CF₃; R^{4a} is Me or CH(CH₃)₂; R^{4b} is H; R⁵ is Cl; and R⁶ is H.

### Embodiment 1C

The method of Embodiment 1 wherein the carboxamide arthropodicide is selected from the group consisting of:
N-[4-chloro-2-methyl-6-[[(1-methylethyl)amino]carbonyl]phenyl]-1-(3-chloro-2-pyridinyl)-3-(trifluoromethyl)-1H-pyrazole-5-carboxamide,
N-[4-chloro-2-methyl-6-[(methylamino)carbonyl]phenyl]-1-(3-chloro-2-pyridinyl)-3-(trifluoromethyl)-1H-pyrazole-5-carboxamide,
3-bromo-N-[4-chloro-2-methyl-6-[[(1-methylethyl)amino]carbonyl]phenyl]-1-(3-chloro-2-pyridinyl)-1H-pyrazole-5-carboxamide,
3-bromo-N-[4-chloro-2-methyl-6-[(methylamino)carbonyl]phenyl]-1-(3-chloro-2-pyridinyl)-1H-pyrazole-5-carboxamide,
3-bromo-1-(3-chloro-2-pyridinyl)-N-[4-cyano-2-methyl-6-[(methylamino)-carbonyl]phenyl]-1H-pyrazole-5-carboxamide,
1-(3-chloro-2-pyridinyl)-N-[4-cyano-2-methyl-6-[(methylamino)carbonyl]-phenyl]-3-(trifluoromethyl)-1H-pyrazole-5-carboxamide,
3-bromo-1-(2-chlorophenyl)-N-[4-cyano-2-methyl-6-[[(1-methylethyl)amino]-carbonyl]phenyl]-1H-pyrazole-5-carboxamide,
3-bromo-1-(2-chlorophenyl)-N-[4-cyano-2-methyl-6-[(methylamino)carbonyl]-phenyl]-1H-pyrazole-5-carboxamide,
3-bromo-1-(2-chlorophenyl)-N-[2,4-dichloro-6-[(methylamino)carbonyl]-phenyl]-1H-pyrazole-5-carboxamide,
3-bromo-N-[4-chloro-2-[[(cyclopropylmethyl)amino]carbonyl]-6-methylphenyl]-1-(3-chloro-2-pyridinyl)-1H-pyrazole-5-carboxamide,
3-bromo-1-(3-chloro-2-pyridinyl)-N-[4-cyano-2-[[(cyclopropylmethyl)amino]-carbonyl]-6-methylphenyl]-1H-pyrazole-5-carboxamide,
3-bromo-N-[4-chloro-2-[[(1-cyclopropylethyl)amino]carbonyl]-6-methylphenyl]-1-(3-chloro-2-pyridinyl)-1H-pyrazole-5-carboxamide, and
3-bromo-1-(3-chloro-2-pyridinyl)-N-[4-cyano-2-[[(1-cyclopropylethyl)amino]-carbonyl]-6-methylphenyl]-1H-pyrazole-5-carboxamide.

In an embodiment, an anthranilamide of Formula 1, an N-oxide, or a salt thereof,

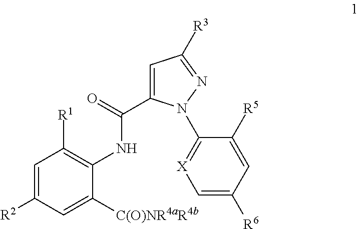

wherein
X is N, CF, CCl, CBr or Cl;
R¹ is CH₃, Cl, Br or F;
R² is H, F, Cl, Br or CN;
R³ is F, Cl, Br, C₁-C₄ haloalkyl C₁-C₄ haloalkoxy or [5-(trifluoromethyl)-2H-tetrazol-2-yl]methyl;
R^{4a} is H, C₁-C₄ alkyl, cyclopropylmethyl or 1-cyclopropylethyl;
R^{4b} is H or CH₃;
or alternatively the —C(O)NR^{4a}R^{4b} moiety can be selected from the group consisting of N═S(CH₃)₂, N═S(CH₂CH₃)₂ or N═S(CH(CH₃)₂)₂;
R⁵ is H, F, Cl or Br; and
R⁶ is H, F, Cl or Br.

### Embodiment 2

The methods described in the Summary of the Disclosure wherein the carboxamide arthropodicide is selected from a phthalic diamide of Formula 2 or a salt thereof,

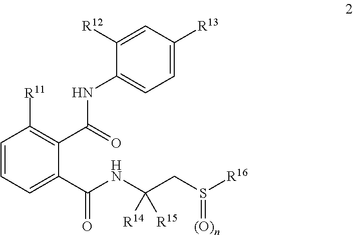

wherein
R¹¹ is CH₃, Cl, Br or I;
R¹² is CH₃ or Cl;
R¹³ is C₁-C₃ fluoroalkyl;
R¹⁴ is H or CH₃;
R¹⁵ is H or CH₃;
R¹⁶ is C₁-C₂ alkyl; and
n is 0, 1 or 2.

### Embodiment 2B

The methods of Embodiment 2 wherein R¹¹ is Cl, Br or I; R¹² is CH₃; R¹³ is CF₃, CF₂CF₃ or CF(CF₃)₂ (equivalently identified as (CF₃)₂CF); R¹⁴ is H or CH₃; R¹⁵ is H or CH₃; R¹⁶ is CH₃; and n is 0, 1 or 2.

### Embodiment 2C

The methods of Embodiment 2 wherein the carboxamide arthropodicide is N²-[1,1-dimethyl-2-(methylsulfonyl)ethyl]-3-iodo-N¹-[2-methyl-4-[1,2,2,2-tetrafluoro-1-(trifluoromethyl)ethyl]phenyl]-1,2-benzenedicarboxamide.

### Embodiment 3

The methods described in the Summary of the Disclosure wherein the arthropod pest is a species in one of the orders Coleoptera, Diptera, Hemiptera, Homoptera, Lepidoptera, and Thysanoptera.

### Embodiment 4

The methods of Embodiment 3 wherein the arthropod pest is a species of the order Coleptera.

### Embodiment 4A

The methods of Embodiment 4 wherein the arthropod pest is Anthonomus eugenii.

### Embodiment 5

The methods of Embodiment 3 wherein the arthropod pest is a species of the order Diptera.

### Embodiment 5A

The methods of Embodiment 5 wherein the arthropod pest is Musca domestica.

### Embodiment 6

The methods of Embodiment 3 wherein the arthropod pest is a species of the order Hemiptera.

### Embodiment 6A

The methods of Embodiment 6 wherein the arthropod pest is a Euschistus species.

### Embodiment 6B

The methods of Embodiment 6 wherein the arthropod pest is Nezara viridula.

### Embodiment 6C

The methods of Embodiment 6 wherein the arthropod pest is a Dychelops species.

### Embodiment 7

The methods of Embodiment 3 wherein the arthropod pest is a species of the order Homoptera.

### Embodiment 7A

The methods of Embodiment 7 wherein the arthropod pest is Aphis gossypii.

### Embodiment 7B

The methods of Embodiment 7 wherein the arthropod pest is Bemisia argentifolii.

### Embodiment 7C

The methods of Embodiment 7 wherein the arthropod pest is Diaphorina citri.

### Embodiment 7D

The methods of Embodiment 7 wherein the arthropod pest is Empoasca fabae.

### Embodiment 7E

The methods of Embodiment 7 wherein the arthropod pest is Myzus persicae.

### Embodiment 7F

The methods of Embodiment 7 wherein the arthropod pest is Nephotettix virescens.

### Embodiment 7G

The methods of Embodiment 7 wherein the arthropod pest is Nilaparvata lugens.

### Embodiment 7H

The methods of Embodiment 7 wherein the arthropod pest is Toxoptera citricida.

### Embodiment 8

The methods of Embodiment 3 wherein the arthropod pest is a species of the order Lepidoptera.

### Embodiment 8A

The methods of Embodiment 8 wherein the arthropod pest is Spodoptera exigua.

### Embodiment 9

The methods of Embodiment 3 wherein the arthropod pest is a species of the order Thysanoptera.

### Embodiment 9A

The methods of Embodiment 9 wherein the arthropod pest is Thrips palmi.

### Embodiment 10

The methods described in the Summary of the Disclosure or any of the embodiments described herein comprising contacting an arthropod pest or its environment with a composition comprising a sub-lethal amount of a carboxamide arthropodicide, its N-oxide, or a salt thereof, and at least one additional component selected from the group consisting of surfactants, solid diluents and liquid diluents.

### Embodiment 11

The methods of Embodiment 10 wherein the composition further comprises a biologically effective amount of a sex pheromone.

In an embodiment, the anthranilamide used is chlorantraniliprole (Experimental name DPX-E2Y45; IUPAC name 3-Bromo-N-[4-chloro-2-methyl-6-(methylcarbamoyl)phenyl]-1-(3-chloro-2-pyridine-2-yl)-1H-pyrazole-5-carboxamide; CAS name 3-Bromo-N-[4-chloro-2-methyl-6-[(methylamino)carbonyl]phenyl]-1-(3-chloro-2-pyridinyl)-1H-pyrazole-5-carboxamide; and CAS registry number 500008-45-7.

In an embodiment, the anthranilamide used is cyantraniliprole (Experimental name DPX-HGW86; IUPAC name 3-bromo-1-(3-chloro-2-pyridyl)-4′-cyano-2′-methyl-6′-(methylcarbamoyl)pyrazole-5-carboxanilide; CAS name 3-bromo-1-(3-chloro-2-pyridinyl)-N-[4-cyano-2-methyl-6-[(methylamino)carbonyl]phenyl]-1H-pyrazole-5-carboxamide; and CAS registry number 736994-63-1.

In the above recitations, the term “alkyl”, used either alone or in compound words such as “haloalkyl” or “fluoroalkyl” includes straight-chain or branched alkyl, such as, methyl, ethyl, n-propyl, i-propyl, or the different butyl isomers. “Alkoxy” includes, for example, methoxy, ethoxy, n-propyloxy, isopropyloxy and the different butoxy isomers. The term “halogen”, either alone or in compound words such as “haloalkyl”, includes fluorine, chlorine, bromine or iodine. Further, when used in compound words such as “haloalkyl” or “haloalkoxy”, said alkyl may be partially or fully substituted with halogen atoms which may be the same or different. Examples of “haloalkyl” include F₃C, ClCH₂, CF₃CH₂ and CF₃CCl₂. The terms “haloalkoxy”, and the like, are defined analogously to the term “haloalkyl”. Examples of “haloalkoxy” include CF₃O, CCl₃CH₂O, CHF₂CH₂CH₂O and CF₃CH₂O.

The total number of carbon atoms in a substituent group is indicated by the “Cᵢ-Cⱼ” prefix where i and j are numbers from 1 to 4. For example, C₁-C₄ alkyl designates methyl through butyl, including the various isomers.

Carboxamide arthropodicides (e.g., Formulae 1 or 2) for the method of this disclosure can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. These carboxamide arthropodicides may be present as a mixture of stereoisomers, individual stereoisomers, or as an optically active form.

Anthranilamides of Formula 1 can be prepared as described in U.S. Pat. No. 6,747,047, PCT Publications WO 2003/015518 and WO 2004/067528, and phthalic diamides of Formula 2 can be prepared as described in U.S. Pat. No. 6,603,044.

The carboxamide arthropodicides (e.g., Formula 1) for the present method can also be in the form of N-oxides. One skilled in the art will appreciate that not all nitrogen-containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethyldioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

One skilled in the art recognizes that because in the environment and under physiological conditions salts of chemical compounds are in equilibrium with their corresponding nonsalt forms, salts share the biological utility of the nonsalt forms. Thus a wide variety of salts of carboxamide arthropodicides (e.g., Formulae 1 or 2) are useful in the present methods (i.e. are agriculturally suitable). Such salts include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Salts can also include those formed with organic bases (e.g., pyridine, ammonia, or triethylamine) or inorganic bases (e.g., hydrides, hydroxides, or carbonates of sodium, potassium, lithium, calcium, magnesium or barium) when the carboxamide arthropodicide contains an acidic group such as a carboxylic acid or phenol.

### Formulation/Utility

The carboxamide arthropodicides according to the methods of this disclosure can generally be used as a formulation or a composition with a carrier suitable for agronomic or nonagronomic uses comprising at least one of a liquid diluent or a surfactant. Suitable formulations are disclosed in U.S. Pat. No. 6,747,047, PCT Publications WO 2003/015518, WO 2004/067528 and U.S. Pat. No. 6,603,044.

The formulations will typically contain effective amounts of active ingredient, diluent and surfactant within the following approximate ranges which add up to 100 percent by weight. Said formulated composition can then be diluted with water to the desired sub-lethal, disease transmission-disruptive application rates. Examples of suitable compositions comprising a sub-lethal, disease transmission-disruptive amount of a carboxamide arthropodicide include liquid compositions comprising water, organic solvent, or oil as a liquid diluent.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets | | | |
| and Powders. | | | |
| Suspensions, Emulsions, | 1-50 | 40-99 | 0-50 |
| Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, U K, 2000.

In the methods of this disclosure the carboxamide arthropodicide of the disclosure is sometimes contacted with an arthropod pest or its environment in the form of a composition comprising in addition to the carboxamide arthropodicide at least one additional component selected from the group consisting of a surfactant and a liquid diluent. Thus the present disclosure also pertains to a method wherein a composition comprising a sub-lethal, disease transmission-disruptive amount of a carboxamide arthropodicide and at least one of a surfactant or a liquid diluent in contacted with the arthropod pest or its environment.

Methods of this disclosure can be applied to plants genetically transformed to express proteins toxic to invertebrate pests (such as Bacillus thuringiensis delta-endotoxins). The effect of the exogenously applied sub-lethal amount of the carboxamide arthropodicide according to a method of this disclosure may be synergistic with the expressed toxin proteins in disrupting infectious disease transmission.

In certain instances, combinations with other arthropodicides having a similar spectrum of control but a different mode of action will be particularly advantageous for resistance management. General references for other arthropodicides include The Pesticide Manual, 13th Edition, C. D. S. Tomlin, Ed., British Crop Protection Council, Farnham, Surrey, U. K., 2003 and The BioPesticide Manual, 2nd Edition, L. G. Copping, Ed., British Crop Protection Council, Farnham, Surrey, U. K., 2001.

Transmission of disease by arthropod pests is disrupted in agronomic and nonagronomic applications by applying a composition comprising a carboxamide arthropodicide in a sub-lethal, disruptive amount to the environment of the pests, including the agronomic and/or nonagronomic locus of infestation, to the area to be protected, or directly on the pests to be controlled. Agronomic applications include protecting a field crop from disease transmission by the arthropod pest is accomplished typically by applying a composition comprising a carboxamide arthropodicide in a sub-lethal, disruptive amount to the seed of the crop before planting, to the foliage, stems, flowers and/or fruit of crop plants, or to the soil or other growth medium before or after the crop is planted.

The disruption of infectious disease transmission at sub-lethal doses is in itself an unexpected effect. We have also discovered that over and above any effects related to infectious disease transmission or inhibition of feeding the methods of the disclosure also increase crop vigor and crop yields.

Nonagronomic applications relate to disruption of arthropod pests in areas other than fields of crop plants. Nonagronomic applications include disruption of arthropod disease transmission in ornamental plants, forests, orchards, in yards, and on turf such as lawns, golf courses and pastures. Nonagronomic applications also include protecting human and animal health by disruption of the transmission of human and animal diseases by arthropod pests that are parasitic or transmit human and animal infectious diseases. Such pests include, for example, chiggers, ticks, lice, mosquitoes, flies and fleas.

Disease transmission by arthropod pests is disrupted and protection of agronomic and other crops, and animal and human health is achieved by applying a composition comprising a carboxamide arthropodicide in a sub-lethal, disruptive amount to the environment of the pests including the agronomic and/or nonagronomic locus of infestation, to the area to be protected, or directly on the pests. Therefore, the present disclosure comprises a method for disrupting the transmission of infectious plant diseases by an arthropod pest in agronomic and/or nonagronomic applications, comprising contacting the arthropod pest or its environment with a sub-lethal, disruptive amount of a carboxamide arthropodicide, or with a composition comprising a sub-lethal, disruptive amount of a carboxamide arthropodicide. More particularly, the present disclosure comprises a method for the disruption of the transmission of infectious plant disease by foliar and soil-inhabiting arthropods and protection of agronomic and/or nonagronomic crops, comprising applying a composition comprising a carboxamide arthropodicide in a sub-lethal, disruptive amount to the environment of the pests including the agronomic and/or nonagronomic locus of infestation, to the area to be protected, or directly on the arthropod pests.

One embodiment of a method of contact is by spraying the pest and/or the environment of the pest. Alternatively, according to the method of the present disclosure, the carboxamide arthropodicide can be effectively delivered through plant uptake by contacting the plant with a composition comprising a sub-lethal, disruptive amount of a carboxamide arthropodicide applied as a soil drench of a liquid formulation.

Of note is a method for disrupting the transmission of plant infectious disease by an arthropod pest comprising contacting the soil environment of the arthropod pest with a sub-lethal, disruptive amount of a carboxamide. Of further note is the method of this disclosure comprising topical application to the locus of infestation. Other methods of contact include application of a carboxamide arthropodicide according to the methods of the disclosure by direct and residual sprays, aerial sprays, gels, seed coatings, microencapsulations, systemic uptake, baits, ear tags, boluses, foggers, fumigants, aerosols, dusts and many others. The carboxamide arthropodicide according to the methods of this disclosure can also be impregnated into materials for fabricating arthropod control devices (e.g., insect netting). Seed coatings can be applied to all types of seeds, including those from which plants genetically transformed to express specialized traits will germinate. Representative examples include those expressing proteins toxic to invertebrate pests, such as Bacillus thuringiensis toxin or those expressing herbicide resistance, such as “Roundup Ready” seed.

The carboxamide arthropodicide according to the method of this disclosure can be applied at rates equal or below LC₅₀ without other adjuvants, but most often application will be of a formulation comprising the carboxamide arthropodicide in combination with suitable carriers, diluents, and surfactants and possibly in combination with a food (to facilitate initial ingestion) depending on the contemplated end use. One method of application involves spraying a water dispersion or refined oil solution of a carboxamide arthropodicide. Combinations with spray oils, spray oil concentrations, spreader stickers, adjuvants, other solvents, and synergists such as piperonyl butoxide often enhance efficacy. For nonagronomic uses such sprays can be applied from spray containers such as a can, a bottle or other container, either by means of a pump or by releasing it from a pressurized container, e.g., a pressurized aerosol spray can. Such spray compositions can take various forms, for example, sprays, mists, foams, fumes or fog. Such spray compositions thus can further comprise propellants, foaming agents, etc. as the case may be. Of note is a spray composition comprising a sub-lethal, disruptive amount of a carboxamide arthropodicide or a composition comprising a sub-lethal, disruptive amount of a carboxamide arthropodicide of the present disclosures and a carrier. One embodiment of such a spray composition comprises a sub-lethal, disruptive amount of a carboxamide arthropodicide or a composition comprising a sub-lethal, disruptive amount of a carboxamide arthropodicide of the present disclosure and a propellant. Representative propellants include, but are not limited to, methane, ethane, propane, butane, isobutane, butene, pentane, isopentane, neopentane, pentene, hydrofluorocarbons, chlorofluorocarbons, dimethyl ether, and mixtures of the foregoing. Of note is a spray composition (and a method utilizing such a spray composition dispensed from a spray container) used to control at least one arthropod pest selected from the group consisting of mosquitoes, black flies, stable flies, deer flies, horse flies, wasps, yellow jackets, hornets, ticks, spiders, ants, gnats, and the like, including individually or in combinations.

As referred to in this disclosure, the term “invertebrate pest” includes arthropods, gastropods and nematodes of economic importance as pests. The term “phytophagous invertebrate pest” refers to invertebrate pests causing injury to plants by feeding upon them, such as by eating foliage, stem, leaf, fruit or seed tissue or by sucking the vascular juices of plants. The term “arthropod” includes insects, mites, centipedes, millipedes, pill bugs and symphylans. The term “gastropod” includes snails, slugs and other Stylommatophora. The term “nematode” includes the phytophagous nematodes (Phylum or Class Nematoda). Economically important phytophagous invertebrate pests include: larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilon Hufnagel), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), sod webworm (Herpetogramma licarsisalis Walker)); leafrollers, budworms, seed worms, and fruit worms in the family Tortricidae (e.g., codling moth (Cydia pomonella L. (L. means Linnaeus)), grape berry moth (Endopiza viteana Clemens), oriental fruit moth (Grapholita molesta Busck)); and many other economically important lepidoptera (e.g., diamondback moth (Plutella xylostella L.), pink bollworm (Pectinophora gossypiella Saunders), gypsy moth (Lymantria dispar L.)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), rice weevil (Sitophilus oryzae L.)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera virgifera LeConte)); chafers and other beetles from the family Scaribaeidae (e.g., Japanese beetle (Popillia japonica Newman) and European chafer (Rhizotrogus majalis Razoumowsky)); wireworms from the family Elateridae and bark beetles from the family Scolytidae; adults and larvae of the order Dermaptera including earwigs from the family Forficulidae (e.g., European earwig (Forficula auricularia L.), black earwig (Chelisoches morio Fabricius)); adults and nymphs of the orders Hemiptera and Homoptera such as, plant bugs from the family Miridae, cicadas from the family Cicadidae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coreidae, and red bugs and cotton stainers from the family Pyrrhocoridae; adults and larvae of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)), flat mites in the family Tenuipalpidae (e.g., citrus flat mite (Brevipalpus lewisi McGregor)), rust and bud mites in the family Eriophyidae and other foliar feeding mites; adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria L.), mole crickets (Gryllotalpa spp.)); adults and immatures of the order Diptera including leafminers, midges, fruit flies (Tephritidae), frit flies (e.g., Oscinella frit L.), soil maggots and other Nematocera; adults and immatures of the order Thysanoptera including onion thrips (Thrips tabaci Lindeman) and other foliar feeding thrips; and centipedes in the order Scutigeromorpha; and members of the Phylum or Class Nematoda including such important agricultural pests as root knot nematodes in the genus Meloidogyne, lesion nematodes in the genus Pratylenchus, stubby root nematodes in the genus Trichodorus, etc.

Those skilled in the art will recognize that not all compounds are equally effective against all pests. Compounds of the disclosure show particularly high activity against pests in the order Lepidoptera (e.g., Alabama argillacea Hübner (cotton leaf worm), Archips argyrospila Walker (fruit tree leaf roller), A. rosana L. (European leaf roller) and other Archips species, Chilo suppressalis Walker (rice stem borer), Cnaphalocrosis medinalis Guenee (rice leaf roller), Crambus caliginosellus Clemens (corn root webworm), Crambus teterrellus Zincken (bluegrass webworm), Cydia pomonella L. (codling moth), Earias insulana Boisduval (spiny bollworm), Earias vittella Fabricius (spotted bollworm), Helicoverpa armigera Hubner (American bollworm), Helicoverpa zea Boddie (corn earworm), Heliothis virescens Fabricius (tobacco budworm), Herpetogramma licarsisalis Walker (sod webworm), Lobesia botrana Denis & Schiffermüller (grape berry moth), Pectinophora gossypiella Saunders (pink bollworm), Phyllocnistis citrella Stainton (citrus leafminer), Pieris brassicae L. (large white butterfly), Pieris rapae L. (small white butterfly), Plutella xylostella L. (diamondback moth), Spodoptera exigua Hübner (beet armyworm), Spodoptera litura Fabricius (tobacco cutworm, cluster caterpillar), Spodoptera frugiperda J. E. Smith (fall armyworm), Trichoplusia ni Hübner (cabbage looper) and Tuta absoluta Meyrick (tomato leafminer)). Compounds of the disclosure also have commercially significant activity on members from the order Homoptera including: Acyrthisiphon pisum Harris (pea aphid), Aphis craccivora Koch (cowpea aphid), Aphis fabae Scopoli (black bean aphid), Aphis gossypii Glover (cotton aphid, melon aphid), Aphis pomi De Geer (apple aphid), Aphis spiraecola Patch (spirea aphid), Aulacorthum solani Kaltenbach (foxglove aphid), Chaetosiphon fragaefolii Cockerell (strawberry aphid), Diuraphis noxia Kurdjumov/Mordvilko (Russian wheat aphid), Dysaphis plantaginea Paaserini (rosy apple aphid), Eriosoma lanigerum Hausmann (woolly apple aphid), Hyalopterus pruni Geoffroy (mealy plum aphid), Lipaphis erysimi Kaltenbach (turnip aphid), Metopolophium dirrhodum Walker (cereal aphid), Macrosipum euphorbiae Thomas (potato aphid), Myzus persicae Sulzer (peach-potato aphid, green peach aphid), Nasonovia ribisnigri Mosley (lettuce aphid), Pemphigus spp. (root aphids and gall aphids), Rhopalosiphum maidis Fitch (corn leaf aphid), Rhopalosiphum padi L. (bird cherry-oat aphid), Schizaphis graminum Rondani (greenbug), Sitobion avenae Fabricius (English grain aphid), Therioaphis maculata Buckton (spotted alfalfa aphid), Toxoptera aurantii Boyer de Fonscolombe (black citrus aphid), and Toxoptera citricida Kirkaldy (brown citrus aphid); Adelges spp. (adelgids); Phylloxera devastatrix Pergande (pecan phylloxera); Bemisia tabaci Gennadius (tobacco whitefly, sweetpotato whitefly), Bemisia argentifolii Bellows & Perring (silverleaf whitefly), Dialeurodes citri Ashmead (citrus whitefly) and Trialeurodes vaporariorum Westwood (greenhouse whitefly); Empoasca fabae Harris (potato leafhopper), Laodelphax striatellus Fallen (smaller brown planthopper), Macrolestes quadrilineatus Forbes (aster leafhopper), Nephotettix cinticeps Uhler (green leafhopper), Nephotettix nigropictus Stål (rice leafhopper), Nilaparvata lugens Stål (brown planthopper), Peregrinus maidis Ashmead (corn planthopper), Sogatella furcifera Horvath (white-backed planthopper), Sogatodes orizicola Muir (rice delphacid), Typhlocyba pomaria McAtee white apple leafhopper, Erythroneoura spp. (grape leafhoppers); Magicidada septendecim L. (periodical cicada); Icerya purchasi Maskell (cottony cushion scale), Quadraspidiotus perniciosus Comstock (San Jose scale); Planococcus citri Risso (citrus mealybug); Pseudococcus spp. (other mealybug complex); Cacopsylla pyricola Foerster (pear psylla), Trioza diospyri Ashmead (persimmon psylla). These compounds also have activity on members from the order Hemiptera including: Acrosternum hilare Say (green stink bug), Anasa tristis De Geer (squash bug), Blissus leucopterus leucopterus Say (chinch bug), Corythuca gossypii Fabricius (cotton lace bug), Cyrtopeltis modesta Distant (tomato bug), Dysdercus suturellus Herrich-Schäffer (cotton stainer), Euchistus servus Say (brown stink bug), Euchistus variolarius Palisot de Beauvois (one-spotted stink bug), Graptosthetus spp. (complex of seed bugs), Leptoglossus corculus Say (leaf-footed pine seed bug), Lygus lineolaris Palisot de Beauvois (tarnished plant bug), Nezara viridula L. (southern green stink bug), Oebalus pugnax Fabricius (rice stink bug), Oncopeltus fasciatus Dallas (large milkweed bug), Pseudatomoscelis seriatus Reuter (cotton fleahopper). Other insect orders controlled by compounds of the disclosure include Thysanoptera (e.g., Frankliniella occidentalis Pergande (western flower thrip), Scirthothrips citri Moulton (citrus thrip), Sericothrips variabilis Beach (soybean thrip), and Thrips tabaci Lindeman (onion thrip); and the order Coleoptera (e.g., Leptinotarsa decemlineata Say (Colorado potato beetle), Epilachna varivestis Mulsant (Mexican bean beetle) and wireworms of the genera Agriotes, Athous or Limonius).

The method of this disclosure is applicable to virtually all plant species. Seeds that can be treated, include for example, wheat (Triticum aestivum L.), durum wheat (Triticum durum Desf.), barley (Hordeum vulgare L.) oat (Avena sativa L.), rye (Secale cereale L.), maize (Zea mays L.), sorghum (Sorghum vulgare Pers.), rice (Oryza sativa L.), wild rice (Zizania aquatica L.), cotton (Gossypium barbadense L. and G. hirsutum L.), flax (Linum usitatissimum L.), sunflower (Helianthus annuus L.), soybean (Glycine max Merr.), garden bean (Phaseolus vulgaris L.), lima bean (Phaseolus limensis Macf.), broad bean (Vicia faba L.), garden pea (Pisum sativum L.), peanut (Arachis hypogaea L.), alfalfa (Medicago sativa L.), beet (Beta vulgaris L.), garden lettuce (Lactuca sativa L.), rapeseed (Brassica rapa L. and B. napus L.), cole crops such as cabbage, cauliflower and broccoli (Brassica oleracea L.), turnip (Brassica rapa L.), leaf (oriental) mustard (Brassica juncea Coss.), black mustard (Brassica nigra Koch), tomato (Lycopersicon esculentum Mill.), potato (Solanum tuberosum L.), pepper (Capsicum frutescens L.), eggplant (Solanum melongena L.), tobacco (Nicotiana tabacum), cucumber (Cucumis sativus L.), muskmelon (Cucumis melo L.), watermelon (Citrullus vulgaris Schrad.), squash (Curcurbita pepo L., C. moschata Duchesne. and C. maxima Duchesne.), carrot (Daucus carota L.), zinnia (Zinnia elegans Jacq.), cosmos (e.g., Cosmos bipinnatus Cav.), chrysanthemum (Chrysanthemum spp.), sweet scabious (Scabiosa atropurpurea L.), snapdragon (Antirrhinum majus L.), gerbera (Gerbera jamesonii Bolus), babys-breath (Gypsophila paniculata L., G. repens L. and G. elegans Bieb.), statice (e.g., Limonium sinuatum Mill., L. sinense Kuntze.), blazing star (e.g., Liatris spicata Willd., L. pycnostachya Michx., L. scariosa Willd.), lisianthus (e.g., Eustoma grandiflorum (Raf.) Shinn), yarrow (e.g., Achillea filipendulina Lam., A. millefolium L.), marigold (e.g., Tagetes patula L., T. erecta L.), pansy (e.g., Viola cornuta L., V. tricolor L.), impatiens (e.g., Impatiens balsamina L.) petunia (Petunia spp.), geranium (Geranium spp.) and coleus (e.g., Solenostemon scutellarioides (L.) Codd). Not only seeds, but also rhizomes, tubers, bulbs or corms, including viable cuttings thereof, can be treated according to the disclosure from, for example, potato (Solanum tuberosum L.), sweet potato (Ipomoea batatas L.), yam (Dioscorea cayenensis Lam. and D. rotundata Poir.), garden onion (e.g., Allium cepa L.), tulip (Tulipa spp.), gladiolus (Gladiolus spp.), lily (Lilium spp.), narcissus (Narcissus spp.), dahlia (e.g., Dahlia pinnata Cav.), iris (Iris germanica L. and other species), crocus (Crocus spp.), anemone (Anemone spp.), hyacinth (Hyacinth spp.), grape-hyacinth (Muscari spp.), freesia (e.g., Freesia refracta Klatt., F. armstrongii W. Wats), ornamental onion (Allium spp.), wood-sorrel (Oxalis spp.), squill (Scilla peruviana L. and other species), cyclamen (Cyclamen persicum Mill. and other species), glory-of-the-snow (Chionodoxa luciliae Boiss. and other species), striped squill (Puschkinia scilloides Adams), calla lily (Zantedeschia aethiopica Spreng., Z. elliottiana Engler and other species), gloxinia (Sinnigia speciosa Benth. & Hook.) and tuberous begonia (Begonia tuberhybrida Voss.). Stem cuttings can be treated according to this disclosure include those from such plants as sugarcane (Saccharum officinarum L.), carnation (Dianthus caryophyllus L.), florists chrysanthemum (Chrysanthemum mortifolium Ramat.), begonia (Begonia spp.), geranium (Geranium spp.), coleus (e.g., Solenostemon scutellarioides (L.) Codd) and poinsettia (Euphorbia pulcherrima Willd.). Leaf cuttings which can be treated according to this disclosure include those from begonia (Begonia spp.), african-violet (e.g., Saintpaulia ionantha Wendl.) and sedum (Sedum spp.). The above recited cereal, vegetable, ornamental (including flower) and fruit crops are illustrative, and should not be considered limiting in any way. For reason of invertebrate pest control spectrum and economic importance, seed treatments of cotton, maize, soybean and rice, and tuber and bulb treatments of potato, sweet potato, garden onion, tulip, daffodil, crocus and hyacinth are preferred embodiments of the disclosure.

The locus of the propagules can be treated with a Formula I compound by many different methods. All that is needed is for a biologically effective amount of a Formula I compound to be applied on or sufficiently close to the propagule so that it can be absorbed by the propagule. The Formula I compound can be applied by such methods as drenching the growing medium including a propagule with a solution or dispersion of a Formula I compound, mixing a Formula I compound with growing medium and planting a propagule in the treated growing medium (e.g., nursery box treatments), or various forms of propagule treatments whereby a Formula I compound is applied to a propagule before it is planted in a growing medium.

In these methods the Formula I compound will generally be used as a formulation or composition with an agriculturally suitable carrier comprising at least one of a liquid diluent, a solid diluent or a surfactant. A wide variety of formulations are suitable for this disclosure, the most suitable types of formulations depend upon the method of application. As is well known to those skilled in the art, the purpose of formulation is to provide a safe and convenient means of transporting, measuring and dispensing the crop protection chemical and also to optimize its bioefficacy.

Depending on the method of application useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and surfactant within the following approximate ranges that add up to 100 percent by weight.

| | Weight Percent | | |
|---|---|---|---|
| | Active | | |
| | Ingredients | Diluent | Surfactant |
| Water-Dispersible and Water- | 0.001-90 | 0-99.999 | 0-15 |
| soluble Granules, Tablets | | | |
| and Powders. | | | |
| Suspensions, Emulsions, | 1-50 | 40-99 | 0-50 |
| Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Typical solid diluents are described in Watkins et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Emulsifiers and Detergents and McCutcheon's Functional Materials (North America and International Editions, 2001), The Manufactuing Confection Publ. Co., Glen Rock, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, ethoxylated alcohols, ethoxylated alkylphenols, ethoxylated sorbitan fatty acid esters, ethoxylated amines, ethoxylated fatty acids, esters and oils, dialkyl sulfosuccinates, alkyl sulfates, alkylaryl sulfonates, organosilicones, N,N-dialkyltaurates, glycol esters, phosphate esters, lignin sulfonates, naphthalene sulfonate formaldehyde condensates, polycarboxylates, and block polymers including polyoxy-ethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol, benzyl and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and PCT Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

A propagule or a plant grown therefrom can be protected from an invertebrate pest according to this disclosure by a method comprising contacting the propagule or the locus of the propagule with a composition comprising a biologically effective amount of a compound of Formula I, an N-oxide thereof or an agriculturally suitable salt thereof. The disclosure includes a propagule contacted with a composition comprising a biologically effective amount a compound of Formula I, its N-oxide or an agriculturally suitable salt thereof and an effective amount of at least one other biologically active compound or agent. The compositions used for treating propagules (or plant grown therefrom) according to this disclosure can also comprise (besides the Formula I component) an effective amount of one or more other biologically active compounds or agents. Suitable additional compounds or agents include insecticides, fungicides, nematocides, bactericides, acaricides, growth regulators such as rooting stimulants, chemosterilants, semiochemicals, repellents, attractants, pheromones, feeding stimulants, other biologically active compounds or entomopathogenic bacteria, virus or fungi to form a multi-component pesticide giving an even broader spectrum of agricultural utility. Examples of such biologically active compounds or agents with which compounds of this disclosure can be formulated are: insecticides such as abamectin, acephate, acetamiprid, amidoflumet (S-1955), avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenerim (UR-50701), flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, noviflumuron (XDE-007), oxamyl, parathion, parathion-methyl, permethrin, phorate, phosalone, phosmet, phosphamidon, pirimicarb, profenofos, pymetrozine, pyridalyl, pyriproxyfen, rotenone, spinosad, spiromesifin (BSN 2060), sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), flumorf/flumorlin (SYP-L190), fluoxastrobin (HEC 5725), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), metrafenone (AC 375839), myclobutanil, neo-asozin (ferric methanearsonate), nicobifen (BAS 510), orysastrobin, oxadixyl, penconazole, pencycuron, probenazole, prochloraz, propamocarb, propiconazole, proquinazid (DPX-KQ926), prothioconazole (JAU 6476), pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thuringiensis delta endotoxin, baculovirus, and entomopathogenic bacteria, virus and fungi.

A general reference for these agricultural protectants is The Pesticide Manual, 12th Edition, C. D. S. Tomlin, Ed., British Crop Protection Council, Farnham, Surrey, U. K., 2000.

Preferred insecticides and acaricides for mixing with Formula I compounds include pyrethroids such as cypermethrin, cyhalothrin, cyfluthrin and beta-cyfluthrin, esfenvalerate, fenvalerate and tralomethrin; carbamates such as fenothicarb, methomyl, oxamyl and thiodicarb; neonicotinoids such as clothianidin, imidacloprid and thiacloprid; neuronal sodium channel blockers such as indoxacarb, insecticidal macrocyclic lactones such as spinosad, abamectin, avermectin and emamectin; γ-aminobutyric acid (GABA) antagonists such as endosulfan, ethiprole and fipronil; insecticidal ureas such as flufenoxuron and triflumuron; juvenile hormone mimics such as diofenolan and pyriproxyfen; pymetrozine; and amitraz. Preferred biological agents for mixing with compounds of this disclosure include Bacillus thuringiensis and Bacillus thuringiensis delta endotoxin as well as naturally occurring and genetically modified viral insecticides including members of the family Baculoviridae as well as entomophagous fungi.

Preferred plant growth regulants for mixing with the Formula I compounds in compositions for treating stem cuttings are 1H-indole-3-acetic acid, 1H-indole-3-butanoic acid and 1-naphthaleneacetic acid and their agriculturally suitable salt, ester and amide derivatives, such as 1-napthaleneacetamide. Preferred fungicides for mixing with the Formula I compounds include fungicides useful as seed treatments such as thiram, maneb, mancozeb and captan.

In the following Examples, all percentages are by weight and all formulations are prepared in conventional ways. “Active ingredients” refers to the aggregate of invertebrate pest control agents consisting of component (b) in combination with the compound of Formula 1, an N-oxide or salt thereof. Without further elaboration, it is believed that one skilled in the art using the preceding description can utilize the present disclosure to its fullest extent. The following Examples are, therefore, to be constructed as merely illustrative, and not limiting of the disclosure in any way whatsoever. Percentages are by weight except where otherwise indicated.

### Example A

### Wettable Powder

| | |
|---|---|
| active ingredients | 65.0% |
| dodecylphenol polyethylene | 2.0% |
| glycol ether | |
| sodium ligninsulfonate | 4.0% |
| sodium silicoaluminate | 6.0% |
| montmorillonite (calcined) | 23.0% |

### Example B

### Granule

| | |
|---|---|
| active ingredients | 10.0% |
| attapulgite granules (low | 90.0% |
| volatile matter, 0.71/0.30 mm; | |
| U.S.S. No. 25-50 sieves) | |

### Example C

### Extruded Pellet

| | |
|---|---|
| active ingredients | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 50.0% |

### Example D

### Emulsifiable Concentrate

| | |
|---|---|
| active ingredients | 20.0% |
| blend of oil soluble sulfonates | 10.0% |
| and polyoxyethylene ethers | |
| isophorone | 70.0% |

### Example E

### Microemulsion

| | |
|---|---|
| active ingredients | 5.0% |
| polyvinylpyrrolidone-vinyl | 30.0% |
| acetate copolymer | |
| alkylpolyglycoside | 30.0% |
| glyceryl monooleate | 15.0% |
| water | 20.0% |

### Example F

### Seed Treatment

| | |
|---|---|
| active ingredients | 20.00% |
| polyvinylpyrrolidone-vinyl | 5.00% |
| acetate copolymer | |
| montan acid wax | 5.00% |
| calcium ligninsulfonate | 1.00% |
| polyoxyethylene/polyoxypropylene | 2.00% |
| block copolymers | |
| stearyl alcohol (POE 20) | 0.20% |
| polyorganosilane | 0.05% |
| colorant red dye | 65.75% |
| water | |

### Example G

### Fertilizer Stick

| | |
|---|---|
| active ingredients | 2.50% |
| pyrrolidone-styrene copolymer | 4.80% |
| tristyrylphenyl 16-ethoxylate | 2.30% |
| talc | 0.80% |
| corn starch | 5.00% |
| Nitrophoska ® Permanent | 36.00% |
| 15-9-15 slow-release fertilizer | |
| (BASF) | |
| kaolin | 38.00% |
| water | 10.60% |

For growing-medium drenches, the formulation needs to provide the Formula I compound, generally after dilution with water, in solution or as particles small enough to remain dispersed in the liquid. Water-dispersible or soluble powders, granules, tablets, emulsifiable concentrates, aqueous suspension concentrates and the like are formulations suitable for aqueous drenches of growing media. Drenches are most satisfactory for treating growing media that have relatively high porosity, such as light soils or artificial growing medium comprising porous materials such as peat moss, perlite, vermiculite and the like. The drench liquid comprising the Formula I compound can also be added to a liquid growing medium (i.e. hydroponics), which causes the Formula I compound to become part of the liquid growing medium. One skilled the art will appreciate that the amount of Formula I compound needed in the drench liquid for invertebrate pest control efficacy (i.e. biologically effective amount) will vary with the type of propagule, the Formula I compound, the duration and extent of plant protection desired, the invertebrate pests to be controlled and environmental factors. The concentration of Formula I compound in the drench liquid is generally between about 0.01 ppm and 10,000 ppm, more typically between about 1 ppm and 100 ppm. One skilled in the art can easily determine the biologically effective concentration necessary for the desired level of phytophagous invertebrate pest control.

For treating a growing medium a Formula I compound can also be applied by mixing it as a dry powder or granule formulation with the growing medium. Because this method of application does not require first dispersing or dissolving in water, the dry powder or granule formulations need not be highly dispersible or soluble. While in a nursery box the entire body of growing medium may be treated, in an agricultural field only the soil in the vicinity of the propagule is typically treated for environmental and cost reasons. To minimize application effort and expense, a formulation of Formula I compound is most efficiently applied concurrently with propagule planting (e.g., seeding). For in-furrow application, the Formula I formulation (most conveniently a granule formulation) is applied directly behind the planter shoe. For T-band application, the Formula I formulation is applied in a band over the row behind the planter shoe and behind or usually in front of the press wheel. One skilled the art will appreciate that the amount of Formula I compound needed in the growing medium locus for invertebrate pest control efficacy (i.e. biologically effective amount) will vary with the type of propagule, the Formula I compound, the duration and extent of plant protection desired, the invertebrate pests to be controlled and environmental factors. The concentration of Formula I compound in the growing medium locus of the propagule is generally between about 0.0001 ppm and 100 ppm, more typically between about 0.01 ppm and 10 ppm. One skilled in the art can easily determine the biologically effective amount necessary for the desired level of phytophagous invertebrate pest control.

A propagule can be directly treated by soaking it in a solution or dispersion of a Formula I compound. Although this application method is useful for propagules of all types, treatment of large seeds (e.g., having a mean diameter of at least 3 mm) is more effective than treatment of small seeds for providing invertebrate pest control protection to the developing plant. Treatment of propagules such as tubers, bulbs, corms, rhizomes and stem and leaf cuttings also can provide effective treatment of the developing plant in addition to the propagule. The formulations useful for growing-medium drenches are generally also useful for soaking treatments. The soaking medium comprises a nonphytotoxic liquid, generally water-based although it may contain nonphytotoxic amounts of other solvents such as methanol, ethanol, isopropanol, ethylene glycol, propylene glycol, propylene carbonate, benzyl alcohol, dibasic esters, acetone, methyl acetate, ethyl acetate, cyclohexanone, dimethylsulfoxide and N-methylpyrrolidone, which may be useful for enhancing solubility of the Formula I compound and penetration into the propagule. A surfactant can facilitate wetting of the prop agule and penetration of the Formula I compound. One skilled the art will appreciate that the amount of Formula I compound needed in the soaking medium for invertebrate pest control efficacy (i.e. biologically effective amount) will vary with the type of propagule, the Formula I compound, the duration and extent of plant protection desired, the invertebrate pests to be controlled and environmental factors. The concentration of Formula I compound in the soaking liquid is generally between about 0.01 ppm and 10,000 ppm, more typically between about 1 ppm and 100 ppm. One skilled in the art can easily determine the biologically effective concentration necessary for the desired level of phytophagous invertebrate pest control. The soaking time can vary from 1 minute to 1 day or even longer. Indeed the propagule can remain in the treatment liquid while it is germinating or sprouting (e.g., sprouting of rice seeds prior to direct seeding). As shoot and root emerge through the testa (seed coat), the shoot and root directly contact the solution comprising the Formula I compound. For treatment of sprouting seeds of large-seeded crops such as rice, treatment times of about 8 to 48 hours, e.g., about 24 hours, is typical. Shorter times are most useful for treating small seeds.

A propagule can also be coated with a composition comprising a biologically effective amount of a Formula I compound. The coatings of the disclosure are capable of effecting a slow release of a Formula I compound by diffusion into the propagule and surrounding medium. Coatings include dry dusts or powders adhering to the propagule by action of a sticking agent such as methylcellulose or gum arabic. Coatings can also be prepared from suspension concentrates, water-dispersible powders or emulsions that are suspended in water, sprayed on the propagule in a tumbling device and then dried. Formula I compounds that are dissolved in the solvent can be sprayed on the tumbling propagule and the solvent then evaporated. Such compositions preferably include ingredients promoting adhesion of the coating to the propagule. The compositions may also contain surfactants promoting wetting of the propagule. Solvents used must not be phytotoxic to the propagule; generally water is used, but other volatile solvents with low phytotoxicity such as methanol, ethanol, methyl acetate, ethyl acetate, acetone, etc. may be employed alone or in combination. Volatile solvents are those with a normal boiling point less than about 100° C. Drying must be conducted in a way not to injure the propagule or induce premature germination or sprouting.

The thickness of coatings can vary from adhering dusts to thin films to pellet layers about 0.5 to 5 mm thick. Propagule coatings of this disclosure can comprise more than one adhering layers, only one of which need comprise a Formula I compound. Generally pellets are most satisfactory for small seeds, because their ability to provide a biologically effective amount of a Formula I compound is not limited by the surface area of the seed, and pelleting small seeds also facilitates seed transfer and planting operations. Because of their larger size and surface area, large seeds and bulbs, tubers, corms and rhizomes and their viable cuttings are generally not pelleted, but instead coated with powders or thin films.

Propagules contacted with compounds of Formula I in accordance to this disclosure include seeds. Suitable seeds include seeds of wheat, durum wheat, barley, oat, rye, maize, sorghum, rice, wild rice, cotton, flax, sunflower, soybean, garden bean, lima bean, broad bean, garden pea, peanut, alfalfa, beet, garden lettuce, rapeseed, cole crop, turnip, leaf mustard, black mustard, tomato, potato, pepper, eggplant, tobacco, cucumber, muskmelon, watermelon, squash, carrot, zinnia, cosmos, chrysanthemum, sweet scabious, snapdragon, gerbera, babys-breath, statice, blazing star, lisianthus, yarrow, marigold, pansy, impatiens, petunia, geranium and coleus. Of note are seeds of cotton, maize, soybean and rice. Propagules contacted with compounds of Formula I in accordance to this disclosure also include rhizomes, tubers, bulbs or corms, or viable divisions thereof. Suitable rhizomes, tubers, bulbs and corms, or viable divisions thereof include those of potato, sweet potato, yam, garden onion, tulip, gladiolus, lily, narcissus, dahlia, iris, crocus, anemone, hyacinth, grape-hyacinth, freesia, ornamental onion, wood-sorrel, squill, cyclamen, glory-of-the-snow, striped squill, calla lily, gloxinia and tuberous begonia. Of note are rhizomes, tubers, bulbs and corms, or viable division thereof of potato, sweet potato, garden onion, tulip, daffodil, crocus and hyacinth. Propagules contacted with compounds of Formula I in accordance to this disclosure also include stems and leaf cuttings.

One embodiment of a propagule contacted with a Formula I compound is a propagule coated with a composition comprising a compound of Formula I, its N-oxide or an agriculturally suitable salt thereof and a film former or adhesive agent. Compositions of this disclosure which comprise a biologically effective amount of a compound of Formula I, its N-oxide or an agriculturally suitable salt thereof and a film former or adhesive agent, can further comprise an effective amount of at least one additional biologically active compound or agent. Of note are compositions comprising (in addition to the Formula I component and the film former or adhesive agent) an arthropodicides of the group consisting of pyrethroids, carbamates, neonicotinoids, neuronal sodium channel blockers, insecticidal macrocyclic lactones, γ-aminobutyric acid (GAB A) antagonists, insecticidal ureas and juvenile hormone mimics. Also of note are compositions comprising (in addition to the Formula I component and the film former or adhesive agent) at least one additional biologically active compound or agent selected from the group consisting of abamectin, acephate, acetamiprid, amidoflumet (S-1955), avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenerim (UR-50701), flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, noviflumuron (XDE-007), oxamyl, parathion, parathion-methyl, permethrin, phorate, phosalone, phosmet, phosphamidon, pirimicarb, profenofos, pymetrozine, pyridalyl, pyriproxyfen, rotenone, spinosad, spiromesifin (BSN 2060), sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron, aldicarb, oxamyl, fenamiphos, amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad; and biological agents such as Bacillus thuringiensis including ssp. aizawai and kurstaki, Bacillus thuringiensis delta endotoxin, baculovirus, and entomopathogenic bacteria, virus and fungi. Also of note are compositions comprising (in addition to the Formula I component and the film former or adhesive agent) at least one additional biologically active compound or agent selected from fungicides of the group consisting of acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), flumorf/flumorlin (SYP-L190), fluoxastrobin (HEC 5725), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), metrafenone (AC 375839), myclobutanil, neo-asozin (ferric methanearsonate), nicobifen (BAS 510), orysastrobin, oxadixyl, penconazole, pencycuron, probenazole, prochloraz, propamocarb, propiconazole, proquinazid (DPX-KQ926), prothioconazole (JAU 6476), pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin (especially compositions wherein the at least one additional biologically active compound or agent is selected from fungicides in the group consisting of thiram, maneb, mancozeb and captan).

Generally a propagule coating of the disclosure comprises a compound of Formula I, a film former or sticking agent. The coating may further comprise formulation aids such as a dispersant, a surfactant, a carrier and optionally an antifoam and dye. One skilled the art will appreciate that the amount of Formula I compound needed in the coating for invertebrate pest control efficacy (i.e. biologically effective amount) will vary with the type of propagule, the Formula I compound, the duration and extent of plant protection desired, the invertebrate pests to be controlled and environmental factors. The coating needs to not inhibit germination or sprouting of the propagule and should be consistently efficacious in reducing plant injury during the plant-injury-causing phase of the target invertebrate pest's life cycle. A coating comprising sufficient Formula I compound can provide invertebrate pest control protection for up to about 120 days or even longer. Generally the amount of Formula I compound ranges from about 0.001 to 50% of the weight of the propagule, for seeds more often in the range of about 0.01 to 50% of the seed weight, and most typically for large seeds in the range of about 0.1 to 10% of the seed weight. However, larger amounts up to about 100% or more are useful, particularly for pelleting small seed for extended invertebrate pest control protection. For propagules such as bulbs, tubers, corms and rhizomes and their viable cuttings, and stem and leaf cuttings, generally the amount of Formula I compound ranges from about 0.001 to 5% of the propagule weight, with the higher percentages used for smaller propagules. One skilled in the art can easily determine the biologically effective amount necessary for the desired level of phytophagous invertebrate pest control.

The film former or adhesive agent component of the propagule coating is composed preferably of an adhesive polymer that may be natural or synthetic and is without phytotoxic effect on the propagule to be coated. The film former or sticking agent may be selected from polyvinyl acetates, polyvinyl acetate copolymers, hydrolyzed polyvinyl acetates, polyvinylpyrrolidone-vinyl acetate copolymer, polyvinyl alcohols, polyvinyl alcohol copolymers, polyvinyl methyl ether, polyvinyl methyl ether-maleic anhydride copolymer, waxes, latex polymers, celluloses including ethylcelluloses and methylcelluloses, hydroxy-methylcelluloses, hydroxypropylcellulose, hydroxymethylpropylcelluloses, polyvinyl-pyrrolidones, alginates, dextrins, malto-dextrins, polysaccharides, fats, oils, proteins, karaya gum, jaguar gum, tragacanth gum, polysaccharide gums, mucilage, gum arabics, shellacs, vinylidene chloride polymers and copolymers, soybean-based protein polymers and copolymers, lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof. Preferred film formers and adhesive agents include polymers and copolymers of vinyl acetate, polyvinylpyrrolidone-vinyl acetate copolymer and water-soluble waxes. Particularly preferred are polyvinylpyrrolidone-vinyl acetate copolymers and water-soluble waxes. The above-identified polymers include those known in the art and for example some are identified as Agrimer® VA 6 and Licowax® KST. The amount of film former or sticking agent in the formulation is generally in the range of about 0.001 to 100% of the weight of the propagule. For large seeds the amount of film former or sticking agent is typically in the range of about 0.05 to 5% of the seed weight; for small seeds the amount is typically in the range of about 1 to 100%, but can be greater than 100% of seed weight in pelleting. For other propagules the amount of film former or sticking agent is typically in the range of 0.001 to 2% of the propagule weight.

Materials known as formulation aids may also be used in propagule treatment coatings of the disclosure for the invertebrate pest control and are well known to those skilled in the art. Formulation aids assist in the production or process of propagule treatment and include but are not limited to dispersants, surfactants, carriers, antifoams and dyes. Useful dispersants can include highly water-soluble anionic surfactants like Borresperse™ CA, Morwet® D425 and the like. Useful surfactants can include highly water-soluble nonionic surfactants like Pluronic® F108, Brij® 78 and the like. Useful carriers can include liquids like water and oils which are water soluble such as alcohols. Useful carriers can also include fillers like woodflours, clays, activated carbon, diatomaceous earth, fine-grain inorganic solids, calcium carbonate and the like. Clays and inorganic solids which may be used include calcium bentonite, kaolin, china clay, talc, perlite, mica, vermiculite, silicas, quartz powder, montmorillonite and mixtures thereof. Antifoams can include water dispersible liquids comprising polyorganic siloxanes like Rhodorsil® 416. Dyes can include water dispersible liquid colorant compositions like Pro-lzed® Colorant Red. One skilled in the art will appreciate that this is a non-exhaustive list of formulation aids and that other recognized materials may be used depending on the propagule to be coated and the compound of Formula I used in the coating. Suitable examples of formulation aids include those listed herein and those listed in McCutcheon's 2001, Volume 2: Functional Materials, published by MC Publishing Company. The amount of formulation aids used may vary, but generally the weight of the components will be in the range of about 0.001 to 10000% of the propagule weight, with the percentages above 100% being mainly used for pelleting small seed. For nonpelleted seed generally the amount of formulating aids is about 0.01 to 45% of the seed weight and typically about 0.1 to 15% of the seed weight. For propagules other than seeds, the amount of formulation aids generally is about 0.001 to 10% of the propagule weight.

Conventional means of applying seed coatings may be used to carry out the coating of the disclosure. Dusts or powders may be applied by tumbling the propagule with a formulation comprising a Formula I compound and a sticking agent to cause the dust or powder to adhere to the propagule and not fall off during packaging or transportation. Dusts or powders can also be applied by adding the dust or powder directly to the tumbling bed of propagules, followed by spraying a carrier liquid onto the seed and drying. Dusts and powders comprising a Formula I compound can also be applied by treating (e.g., dipping) a least a portion of the propagule with a solvent such as water, optionally comprising a sticking agent, and dipping the treated portion into a supply of the dry dust or powder. This method can be particularly useful for coating stem cuttings. Propagules can also be dipped into compositions comprising Formula I formulations of wetted powders, solutions, suspoemulsions, emulfiable concentrates and emulsions in water, and then dried or directly planted in the growing medium. Propagules such as bulbs, tubers, corms and rhizomes typically need only a single coating layer to provide a biologically effective amount of a Formula I compound.

Propagules may also be coated by spraying a suspension concentrate directly into a tumbling bed of propagules and then drying the propagules. Alternatively, other formulation types like wetted powders, solutions, suspoemulsions, emulsifiable concentrates and emulsions in water may be sprayed on the propagules. This process is particularly useful for applying film coatings to seeds. Various coating machines and processes are available to one skilled in the art. Suitable processes include those listed in P. Kosters et al., Seed Treatment: Progress and Prospects, 1994 BCPC Monograph No. 57 and the references listed therein. Three well-known techniques include the use of drum coaters, fluidized bed techniques and spouted beds. Propagules such as seeds may be presized prior to coating. After coating the propagules are dried and then optionally sized by transfer to a sizing machine. These machines are known in the art for example, a typical machine used when sizing corn (maize) seed in the industry.

For coating seed, the seed and coating material are mixed in any variety of conventional seed coating apparatus. The rate of rolling and application of coating depends upon the seed. For large oblong seeds such as that of cotton, a satisfactory seed coating apparatus comprises a rotating type pan with lifting vanes turned sufficient rpm to maintain a rolling action of the seed, facilitating uniform coverage. For seed coating formulations applied as liquids, the seed coating must be applied over sufficient time to allow drying to minimize clumping of the seed. Using forced air or heated forced air can allow increasing the rate of application. One skilled in the art will also recognize that this process may be a batch or continuous process. As the name implies, a continuous process allows the seeds to flow continuously throughout the product run. New seeds enter the pan in a steady stream to replace coated seeds exiting the pan.

The seed coating process of the present disclosure is not limited to thin film coating and may also include seed pelleting. The pelleting process typically increases the seed weight from 2 to 100 times and can be used to also improve the shape of the seed for use in mechanical seeders. Pelleting compositions generally contain a solid diluent, which is typically an insoluble particulate material, such as clay, ground limestone, powdered silica, etc. to provide bulk in addition to a binder such as an artificial polymer (e.g., polyvinyl alcohol, hydrolyzed polyvinyl acetates, polyvinyl methyl ether, polyvinyl methyl ether-maleic anhydride copolymer, and polyvinylpyrrolidinone) or natural polymer (e.g., alginates, karaya gum, jaguar gum, tragacanth gum, polysaccharide gum, mucilage). After sufficient layers have been built up, the coat is dried and the pellets graded. A method for producing pellets is described in Agrow, The Seed Treatment Market, Chapter 3, PJB Publications Ltd., 1994.

Neonicotinoids (group (b1))

All neonicotinoids act as agonists at the nicotinic acetylcholine receptor in the central nervous system of insects. This causes excitation of the nerves and eventual paralysis, which leads to death. Due to the mode of action of neonicotinoids, there is no cross-resistance to conventional insecticide classes such as carbamates, organophosphates, and pyrethroids. A review of the neonicotinoids is described in Pestology 2003, 27, pp 60-63; Annual Review of Entomology 2003, 48, pp 339-364; and references cited therein.

Neonicotinoids act as acute contact and stomach poisons, combine systemic properties with relatively low application rates, and are relatively nontoxic to vertebrates. There are many compounds in this group including the pyridylmethylamines such as acetamiprid and thiacloprid; nitromethylenes such as nitenpyram and nithiazine; nitroguanidines such as clothianidin, dinotefuran, imidacloprid and thiamethoxam.

### Other Insecticides, Acaricides, Nematicides

There are many known insecticides, acaricides and nematicides as disclosed in The Pesticide Manual 13^{th} Ed. 2003 including those whose mode of action is not yet clearly defined and those which are a single compound class including amidoflumet (S-1955), bifenazate, chlorofenmidine, dieldrin, diofenolan, fenothiocarb, flufenerim (UR-50701), metaldehyde, metaflumizone (BASF-320), methoxychlor; bactericides such as streptomycin; acaricides such as chinomethionat, chlorobenzilate, cyhexatin, dienochlor, etoxazole, fenbutatin oxide, hexythiazox and propargite.

The weight ratios of component (b) to the compound of Formula 1, an N-oxide, or a salt thereof in the mixtures, compositions and methods of the present disclosure are typically from 150:1 to 1:200, preferably from 150:1 to 1:50, more preferably from 50:1 to 1:10 and most preferably from 5:1 to 1:5. Of note are mixtures, compositions and methods wherein component (b) is a compound selected from (b1) neonicotinoids and the weight ratio of component (b) to the compound of Formula 1, an N-oxide, or a salt thereof is from 150:1 to 1:200. Also of note are mixtures, compositions and methods wherein component (b) is a compound selected from (b2) cholinesterase inhibitors and the weight ratio of component (b) to the compound of Formula 1, an N-oxide, or a salt thereof is from 200:1 to 1:100. Also of note are mixtures, compositions and methods wherein component (b) is a compound selected from (b3) sodium channel modulators and the weight ratio of component (b) to the compound of Formula 1, an N-oxide, or a salt thereof is from 100:1 to 1:10.

Of further note are mixtures, compositions and methods of the present disclosure wherein component (b) is a compound selected from (b1) neonicotinoids and the weight ratio of component (b) to the compound of Formula 1, an N-oxide, or a salt thereof, is from 10:1 to 1:50. Also of note are mixtures, compositions and methods of the present disclosure wherein component (b) is a compound of (b2) cholinesterase inhibitors and the weight ratio of component (b) to the compound of Formula 1, an N-oxide, or a salt thereof, is from 150:1 to 1:25. Of further note are mixtures, composition and methods of the present disclosure wherein component (b) is a compound of (b3) sodium channel modulators and the weight ratio of component (b) to the compound of Formula 1, an N-oxide, or a salt thereof, is from 50:1 to 1:5.

Table A lists specific combinations of the compound of Formula 1 with other invertebrate pest control agents illustrative of the mixtures, compositions and methods of the present disclosure. The first column of Table A lists the group to which the component (b) belongs (e.g., “b1” in the first line). The second column of Table A lists specific invertebrate pest control agents (e.g., “Acetamiprid” in the first line). The third column of Table A lists atypical range of weight ratios of rates at which component (b) is applied relative to the compound of Formula 1 (e.g., “150:1 to 1:200” of acetamiprid relative to the compound of Formula 1 by weight). The fourth and fifth columns respectively list one embodiment of a weight ratio range and another embodiment of a weight ratio range for applications rates. Thus, for example, the first line of Table A specifically discloses the combination of the compound of Formula 1 with acetamiprid, identifies that acetamiprid is a member of component (b) group (b1), and indicates that acetamiprid and the compound of Formula 1 are typically applied in a weight ratio between 150:1 to 1:200, with one embodiment being 10:1 to 1:100 and another embodiment being 5:1 to 1:25. The remaining lines of Table A are to be construed similarly.

TABLE A

| | | | | More |
|---|---|---|---|---|
| | Invertebrate | | | Preferred |
| Component | Pest | Typical | Preferred | Weight |
| (b) | Control Agent | Weight Ratio | Weight Ratio | Ratio |
| b1 | Acetamiprid | 150:1 to 1:200 | 10:1 to 1:100 | 5:1 to 1:25 |
| b1 | Clothianidin | 100:1 to 1:400 | 10:1 to 1:25 | 5:1 to 1:5 |
| b1 | Dinotefuran | 150:1 to 1:500 | 10:1 to 1:100 | 5:1 to 1:25 |
| b1 | Imidacloprid | 100:1 to 1:400 | 10:1 to 1:25 | 5:1 to 1:10 |
| b1 | Nitenpyram | 150:1 to 1:200 | 10:1 to 1:50 | 5:1 to 1:25 |
| b1 | Nithiazine | 150:1 to 1:200 | 10:1 to 1:50 | 5:1 to 1:25 |
| b1 | Thiacloprid | 100:1 to 1:250 | 15:1 to 1:30 | 5:1 to 1:5 |
| b1 | Thiamethoxam | 150:1 to 1:500 | 20:1 to 1:50 | 5:1 to 1:10 |

Of note are mixtures and compositions of this disclosure that can also be mixed with one or more other biologically active compounds or agents including insecticides, fungicides, nematicides, bactericides, acaricides, growth regulators such as rooting stimulants, chemosterilants, semiochemicals, repellents, attractants, pheromones, feeding stimulants, other biologically active compounds or entomopathogenic bacteria, virus or fungi to form a multi-component pesticide giving an even broader spectrum of agricultural or nonagronomic utility.

For further description of composition components and processes suitable for the coating a propagule with a Formula I compound, see U.S. Pat. Nos. 4,443,637, 5,494,709, 5,527,760, 5,834,006, 5,849,320, 5,876,739, 6,156,699, 6,199,318, 6,202,346 and 6,230,438 and European Patent Publication EP-1,078,563-A1.

COMPOUND TABLE 1

| Compound No. | |
|---|---|
| 1 | 3-bromo-N-[4-chloro-2-methyl-6-[(methylamino)carbonyl]phenyl]- |
| | 1-(3-chloro-2-pyridinyl)-1H-pyrazole-5-carboxamide. |
| 2 | 3-bromo-1-(3-chloro-2-pyridinyl)-N-[4-cyano-2-methyl-6-[(methylamino)- |
| | carbonyl]phenyl]-1H-pyrazole-5-carboxamide. |
| 3 | N²-[1,1-dimethyl-2-(methylsulfonyl)ethyl]-3-iodo-N¹-[2-methyl-4- |
| | [1,2,2,2-tetrafluoro-1-(trifluoromethyl)ethyl]phenyl]-1,2- |
| | benzenedicarboxamide. |
| 4 | N-[4-chloro-2-methyl-6-[[(1-methylethyl)amino]carbonyl]phenyl]- |
| | 1-(3-chloro-2-pyridinyl)-3-(trifluoromethyl)-1H-pyrazole-5-carboxamide. |
| 5 | N-[4-chloro-2-methyl-6-[(methylamino)carbonyl]phenyl]-1-(3-chloro- |
| | 2-pyridinyl)-3-(trifluoromethyl)-1H-pyrazole-5-carboxamide. |
| 6 | 3-bromo-N-[4-chloro-2-methyl-6-[[(1-methylethyl)amino]carbonyl]- |
| | phenyl]-1-(3-chloro-2-pyridinyl)-1H-pyrazole-5-carboxamide. |
| 7 | 1-(3-chloro-2-pyridinyl)-N-[4-cyano-2-methyl-6-[(methylamino)carbonyl]- |
| | phenyl]-3-(trifluoromethyl)-1H-pyrazole-5-carboxamide. |
| 8 | 3-bromo-1-(2-chlorophenyl)-N-[4-cyano-2-methyl-6-[[(1-methylethyl)- |
| | amino]carbonyl]phenyl]-1H-pyrazole-5-carboxamide. |
| 9 | 3-bromo-1-(2-chlorophenyl)-N-[4-cyano-2-methyl-6-[(methylamino)- |
| | carbonyl]phenyl]-1H-pyrazole-5-carboxamide. |
| 10 | 3-bromo-1-(2-chlorophenyl)-N-[2,4-dichloro-6-[(methylamino)carbonyl]- |
| | phenyl]-1H-pyrazole-5-carboxamide. |
| 11 | 3-bromo-N-[4-chloro-2-[[(cyclopropylmethyl)amino]carbonyl]-6-methyl- |
| | phenyl]-1-(3-chloro-2-pyridinyl)-1H-pyrazole-5-carboxamide. |
| 12 | 3-bromo-1-(3-chloro-2-pyridinyl)-N-[4-cyano-2-[[(cyclopropylmethyl)- |
| | amino]-carbonyl]-6-methylphenyl]-1H-pyrazole-5-carboxamide. |
| 13 | 3-bromo-N-[4-chloro-2-[[(1-cyclopropylethyl)amino]carbonyl]-6-methyl- |
| | phenyl]-1-(3-chloro-2-pyridinyl)-1H-pyrazole-5-carboxamide. |
| 14 | 3-bromo-1-(3-chloro-2-pyridinyl)-N-[4-cyano-2-[[(1-cyclopropylethyl)- |
| | amino]carbonyl]-6-methylphenyl]-1H-pyrazole-5-carboxamide. |

Methods for preparing the compounds listed in Compound Table 1 are disclosed in U.S. Pat. No. 6,747,047, PCT Publications WO 2003/015518, WO 2004/067528 and U.S. Pat. No. 6,603,044. To the extent necessary to teach the methods of preparing the compounds employed in the disclosure, (and only to the extent that they are not inconsistent with the disclosure herein) these patents and patent publications are herein incorporated by reference.

The Colby equation is used to determine effects expected from the mixtures disclosed herein. (See Colby, S. R. Calculation of the synergistic and antagonistic response of herbicide combinations, Weeds 1967, 15, 20-22.). Colby's equation is used to calculate the expected activity of mixtures containing two active ingredients, e.g., A and B:

Expected=A+B−(A×B/100), wherein

A=observed efficacy of active component A at the same concentration as used in the mixture;

B=observed efficacy of active component B at the same concentration as used in the mixture.

TABLE 1
Seed treatment combination list of Chlorantraniliprole or Cyantraniliprole

| | Chlorantraniliprole or Cyantraniliprole (or a combination thereof) and | | |
|---|---|---|---|
| Crop/Seed | one or more of the following components | | |
| Treatment | | | Other Seed Treatment |
| Combinations | Insecticide | Fungicide | Components |
| Corn | Thiamethoxam, | Azoxystrobin, Fludioxonil, | Bacillus firmus I-1582, |
| | Clothianidin, | Mefenoxam, Thiabendazole, | Bacillus subtilis, Bacillus |
| | | Tebuconazol, Penthiopyrad, | simplex, Abamectin, |
| | | oxathiapiprolin | Polymeric Polyhydroxy |
| | | | Acids |
| Soybean | Imidacloprid, | Metalaxyl, Trifloxystrobin, | Bradyrhizobium |
| | Thiamethoxam | Penthiopyrad, oxathiapiprolin, | japonicum, Bacillus |
| | | Sedaxane, Penflufen, | firmus I-1582, Bacillus |
| | | Prothioconazole, | subtilis, Bacillus simplex, |
| | | Difenoconazole, fluopyram | Pasteuria nishizawae |
| Canola | Thiamethoxam, | Metalaxyl, Picoxystrobin, | Penicillium bilaii, |
| | Clothianidin | Penthiopyrad, Difenoconazole, | |
| | | Trifloxystrobin, Penflufen, | |
| | | Fludioxonil | |

TABLE 2
Suitable biological agents for use with Chlorantraniliprole or Cyantraniliprole

Actinomycetes, Arthrobacter, Azorhizobium, Bacillus, Bacillus firmus,
Brevibacillus, Chaetomium, nterobacter aerogenes, Gliocladium virens, Nomuraea,
Paecilomyces, Pochonia hlamydosporia, Pseudomonas, Pseudomonas putida, Pythium,
Rhizobium, Streptomyces, richoderma, Verticillium, Agrobacterium, Agrobacterium
radiobacter, Aphanomyces, Ascochyta aulina, Aspergillis niger, Aspergillus flavus,
Aspergillus Flavus Oryzae, Aspergillus ustus, Azospirillum, Azospirillum brasilense,
Azospirillum sp, Azospirillum brasilense, Azotobacter, Bacillus amyloliquefaciens, Bacillus
cereus, Bacillus circulans, Bacillus firmus, Bacillus laterosporus, Bacillus licheniformis,
Bacillus megaterium, Bacillus polymyxa, Bacillus popilliae, Bacillus umilus, Bacillus
subtilis, Bacillus subtilis var. amyloliquifaciens strain, Bacillus uniflagellatus, Beijerinckia
indica, Bradyrhizobium japonicum, Burkholderia cepacia, Colletotrichum sp, Coniothyrium
minitans, Coniothyrium minitans Campbell, Coprinus comatus, Coryneform,
Corynobacterium paurometabolum, Cryptococcus albidus, endomycorrhiza, Entomophthora
virulenta, Erwinia carotovora, Eupenicillium, Formononetin, Fusarium, Fusarium
culmorum, Fusarium oxysporum, Gaeumannomyces graminis, Gliocladium catenulatum,
Gliocladium roseum, Gliocladium virens, Glomus spp, Klebsiella pneumonia, Lactobacillus
spp, Lecanicillium muscarium (Verticillium-lecanii), marine-algae, Metarhizium,
Metarhizium anisopliae, Methylobacterium, Myrothecium-verrucaria, Paecilomyces
lilacinus, Paecilomyces fumosoroseus, Paecilomyces variotii, Paenibacillus acerans,
Paenibacillus polymyxa, Pantoea or the genus Leclercia, Pasteuria, Pasteuria nishizawae,
Penicillium, Penicillium bilaii, Penicillium-janthinellum, Phialophora, Phoma cf.
macrostoma, Phytophthora clandestina, Pochonia chlamydosporia, Pseudocercosporella,
Pseudomonas, Pseudomonas aeruginosa, Pseudomonas aureofaciens, Pseudomonas cepacia,
Pseudomonas hlororaphis, Pseudomonas fluorescens, Pseudomonas proradix, Pseudomonas
putida, Pseudomonas esinovoransin, Pseuedomonas corrugata, Pythium oligandrum,
Reynoutria sachalinensis, rhizobacterium, Rhizobium, Rhizobium leguminosarum,
Rhizobium phaseoli, Rhizoctania solani, Rhodopseudomonas-palustris, Saccharomyces
cerevisiae, Scirpophaga, Sclerotinia clerotiorum, Sebacina vermifera, Serratia liquefaciens,
Sinorhizobium meliloti, Sphingobacterium piritivorum, Sporoboloinyces roseus,
Streptomyces, Streptomyces candidus, Streptomyces riseoviridis, STREPTOMYCES
LYDICUS, Talaromyces, Trichoderma, Trichoderma asperellum, Trichoderma hamatum,
Trichoderma virens, Trichoderma atroviride, Trichoderma gamsii trichoderma viride,
trichoderma harzianum, Trichoderma harzianum rifai, Trichoderma-lignorum, Trichoderma
polysporum, Trichoderma stromaticum, Trichoderma oningii, Verticillium
chlamydosporium, Verticillium lecanii, Xanthomonas maltophilia.

Suitable Transgenic Traits (OECD Event Name) for Use with Chlorantraniliprole or Cyantraniliprole as Seed Treatments Include:

DAS-01507-1, DAS-40278-9, MON00603-6, MON89034, DAS-59122-7, MON-88017-3, SYN-IR604-5, MON87427, MON-00021-9, MON 810, MON87460-4, REN-00038-3, MON-00863-5, MON801, MON-7708-9, MON-87705-6, MON-87769-7, MON-87701-2, MON-89788-1, MON-04032-6, MON-87712-4, DAS-06275-8, ACS-ZM005-4, ACS-ZM001-9, ACS-ZM002-1, ACS-ZM003-2, SYN-EV176-9, SYN-05307-, SYN-E3272-5, SYN-IR162-4, SYN-BT011-1, DKB-89614-9, DP-32138-1, DP-098140-6, PH-000676-7, PH-00678-9, PH-000680-2, HCEM485, DP□004114□3, BPS-CV127-9, DP-305423-1, DP-346043-5, DD-026005-, DAS-44406-6, VCO-01981-5, ACS-ZM004-3, MON-80200-7, DKB-89790-5, DAS-81419-2, SYHTH000-2, ST-FG072-3, ACS-GM003-1, ACS-GM006-4, ACS-GM002-9, ACS-GM001-8, ACS-GM005-3, ACS-GM008-6, BCS-GH003-6, DAS-68416-4, MON-887Ø1-3, BCS-GHØØ3-6, BCS-GHØØ4-7×BCS-GHØØ5-8, SYN-R67B-1, BCS-GHØØ2-5, MON-88913-8, SYN-IR1Ø2-7, DAS-21Ø23-5, DAS-24236-5, ACS-GHØØ1-3, MON-5985-7, 31807, DD-Ø1951A-7, MON-Ø1445-2, MON-ØØ531-6, BXN-1Ø211-9, MON-89924-2, MON-Ø757-7, GTL-GFM311-7, GTL-GFM311-7, MON-89383-1, SYN-ØØØH2-5, MON-887Ø1-3, BCS-GHØØ3-6, VCO-Ø1981-5, DAS-444Ø6-6, MON-87712-4, MON-883Ø2-9, DP-Ø73496-4, MON-87427-7, MON-877Ø8-9, BPS-CV127-9.

Suitable native traits for use with Chlorantraniliprole or Cyantraniliprole as seed treatments include for example, Soybean cyst nematode tolerance, Soybean iron deficiency tolerance (e.g., U.S. Pat. No. 7,582,806B2), Corn anthracnose stalk rot (ASR) resistance (e.g., U.S. Pat. No. 8,062,847B2, U.S. Pat. No. 8,062,847B2, and U.S. Pat. No. 8,084,671B2), Anthracnose leaf blight, corn leaf blight, Goss's Wilt, Phytophthora resistance, Grey Leaf Spot, Pythium root/stalk rot, corn rust resistance, corn head smut resistance.

TABLE 3
Cutworm mortality and residual control by
Chlorantraniliprole (E2Y45)

| | OPTIONAL TREATMENT | Mortality | Mortality |
|---|---|---|---|
| TRT# | DESCRIPTION | % 12 DAP | % 39 DAP |
| 1 | E2Y45 250 μg Al/SEED | 100.00 | 32.95 |
| 2 | E2Y45 500 μg Al/SEED | 100.00 | 31.25 |
| 3 | E2Y45 750 μg Al/SEED | 100.00 | 21.11 |
| 4 | E2Y45 + Thiamethoxam 250 + 250 μg | 100.00 | 54.17 |
| | Al/SEED | | |
| 5 | E2Y45 + Thiamethoxam 500 + 250 μg | 100.00 | 52.64 |
| | Al/SEED | | |
| 6 | Clothianidin/B. firmus 1250 | 100.00 | 56.25 |
| 7 | Clothianidin 500 | 97.92 | 25.00 |
| 801 | Thiamethoxam 250 μg Al/SEED | 95.83 | 31.25 |
| 999 | UNTREATED | 2.08 | 14.72 |

TABLE 4
Black cutworm mortality after 10 DAI by
Chlorantraniliprole (E2Y45)

| | OPTIONAL | Mortality | |
|---|---|---|---|
| TRT# | TREATMENT DESCRIPTION | % | LSD 5% |
| 1 | E2Y45 250 μg Al/SEED | 100.00 | a |
| 2 | E2Y45 500 μg Al/SEED | 100.00 | a |
| 3 | E2Y45 750 μg Al/SEED | 100.00 | a |
| 4 | E2Y45 250 + CRUISER 250 μg Al/SEED | 100.00 | a |
| 9 | Clothianidin/B. firmus 1250 | 85.42 | b |
| 10 | Clothianidin 500 | 93.75 | ab |
| 11 | Thiamethoxam 250 μg Al/SEED | 22.92 | d |
| 999 | UNTREATED CHECK | 6.25 | e |

Least Significant Difference (LSD) indicates that whether a particular treatment is statistically significant using the 5% threshold (P ≦ 0.05).
a, b, d, e indicate whether a particular treatment belongs to the same group or different from the other treatments.

### BIOLOGICAL EXAMPLES OF THE DISCLOSURE

### Example 1: Efficacy of Chlorantraniliprole Against Wireworm and Yield Impact on Corn

The larvae of click beetles are called wireworms. The corn wireworm cause significant economic damage to corn throughout the US corn-belt region. One common wireworn species that attacks corn is Melanotus depressus. Wireworms tend to be more abundant and severe in wet cold soils, no-till corn fields, and in fields planted with grasses, alfalfa, and sod. Wireworms injure primarily younger corn plants by feeding on planted seeds, on roots, shoots and crowns of plants below the soil surface, and tunneling into roots and stems of young plants. Damage appears in the form of hollowed out corn kernels leaving only the seed coat, wilted or stunted plants with whorl leaves wilted, and gaps in rows due to poor or weak stands, which reduces yield. Wireworm larvae often live several years in soil and can move deeper in the soil profile as soil temperatures warm. As a result wireworm population in the field may be difficult to predict and manage effectively, thus need for wireworm control through seed treatments exists.

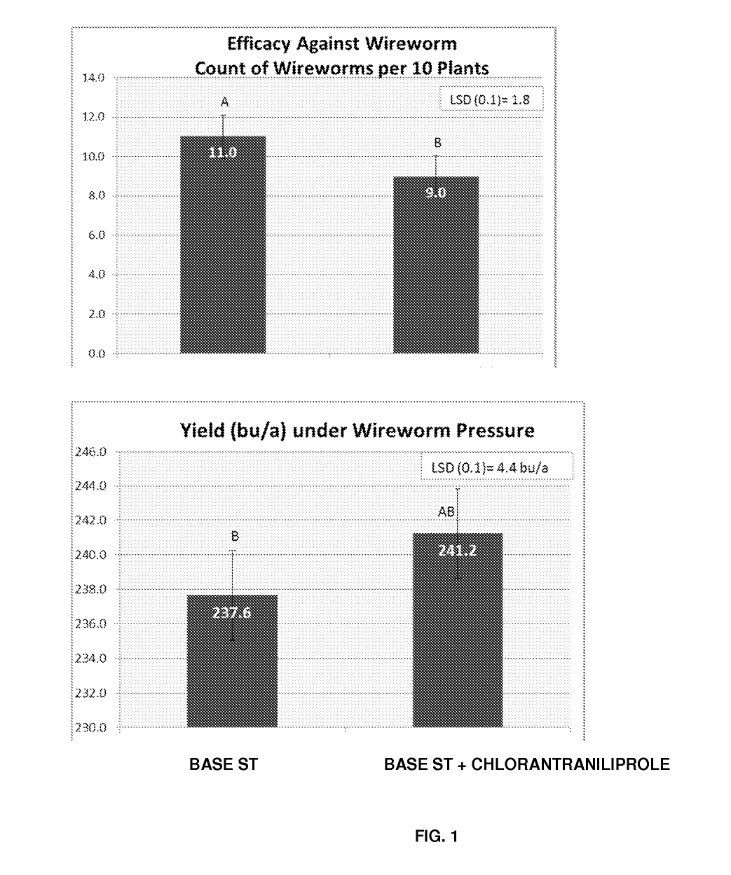

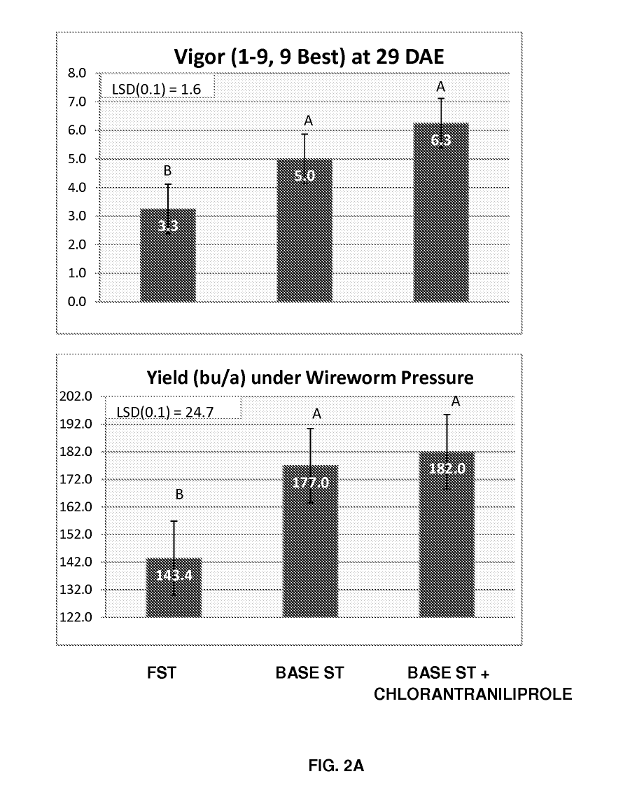

Efficacy of chlorantraniliprole against wireworm (30 DAP) and impact on corn yield were tested (FIG. 1) based on data from 4 Locations. Unless indicated otherwise in this Example or in any other Example herein, “BASE ST” included Fludioxonil, Mefenoxam, Azoxystrobin, Thiabendazole (fungicides), Thiamethoxam (insecticide) and biological amendments (B. subtilis, and B. simplex). The BASE ST may also include other fungicides.

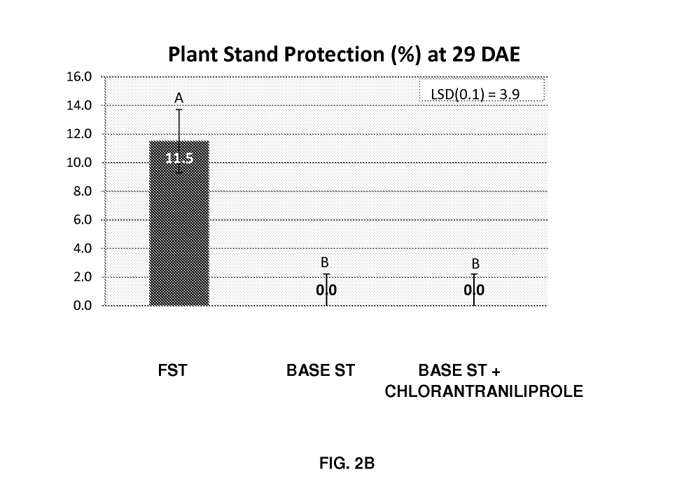

Efficacy of chlorantraniliprole was also tested against high wireworm pressure locations for plant vigor and yield and stand protection (FIG. 2 A-B). “FST” indicates fungicide seed treatment.

The chlorantraniliprole was applied at a concentration of 0.25 mg ai/seed and other commercially available insecticides and/or fungicides were applied at the labeled rates. The dual mode of action provided by the addition of chlorantraniliprole to the BASE ST significantly reduced wireworm count per 10 plants compared to BASE ST alone, resulting in yield increase. In an embodiment, the BASE ST included thiamethoxam at 250 μg AI/seed.

Further, the addition of chlorantraniliprole to the BASE ST significantly increased plant vigor and protected stand compared to FST alone under high wireworm pressure. In addition, yield also increased significantly compared to FST alone (FIG. 2A).

In addition, the efficacy of corn seed treated with chlorantraniliprole to protect seeds and seedlings from soil pests such as wireworms was determined at a growth chamber. A total of 8 repetitions were conducted and the following evaluations were observed:

Evaluations: 1. Emergence; 2. Wireworm damaged plants; 4. Wireworm mortality; 5. Fresh plan weight

Bioassays were conducted in a growth chamber in using field-collected Melanotus spp. wireworms. Six weighted wireworms were individually placed into plastic pots containing filtered field-collected soil and one corn seed for a total of 48 wireworms in 8 pots for each treatment The containers were maintained at 20±2° C., 40 to 70% RH, and a photoperiod of 10:14 (L:D), and were watered daily.

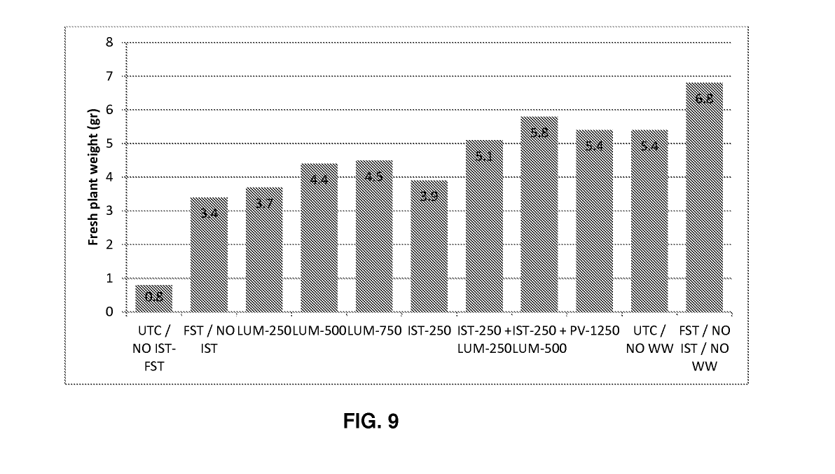

The following seed treatment combinations were used and the results are shown in FIG. 9: Chlorantraniliprole at 250 to 750 μg AI/seed; thiamethoxam (IST) at 250 μg AI/seed; and clothianidin (+Bacillus firmus 1-1582) at 1250 μg AI/seed. Chlorantraniliprole at 250 to 750 μg AI/seed resulted in significantly higher plant weight than the untreated check/control and similar to a thiamethoxam at 250 μg AI/seed; while the combination of chlorantraniliprole and thiamethoxam 250 resulted in similar plant height than clothianidin at 1250 μg AI/seed. These results demonstrate chlorantraniliprole in combination with a low rate insecticide such as thiamethoxam (250 μg AI/seed), applied as a seed treatment provide synergistic control of relevant insects and/or improve plant weight. Chlorantraniliprole at 250 to 750 μg AI/seed and a neonicotinoid insecticide such as thiamethoxam (IST) at 250 μg AI/seed also increased the stand count of corn planted in wireworm pressure locations. Similarly, chlorantraniliprole at 250 to 750 μg AI/seed either alone or in combination with a neonicotinoid insecticide such as thiamethoxam (IST) at 250 μg AI/seed also increased corn grain yield at locations with wireworm infestations.

TABLE 5
Increased yield with chlorantraniliprole on fields with
wireworm pressure

| Treatment | Yield bu/ac |
|---|---|
| Chlorantraniliprole 250 μg AI/seed | 172.3 |
| Chlorantraniliprole 250 μg AI/seed + thiamethoxam 250 μg | 179.7 |
| AI/seed (and other polymers, biological components) | |
| Chlorantraniliprole 500 μg AI/seed + thiamethoxam 250 μg | 182.4 |
| AI/seed (and other polymers, biological components) | |

TABLE 6
Increased yield with chlorantraniliprole and combinations
with a neonicotinoide insecticide on fields with constant
wireworm pressure.

| Treatment (N = 7) | Yield bu/ac |
|---|---|
| Chlorantraniliprole 250 μg AI/seed | 164.3 |
| Chlorantraniliprole 250 μg AI/seed + thiamethoxam 250 μg | 176.8 |
| AI/seed (and other polymers, biological components) | |
| Chlorantraniliprole 500 μg AI/seed + thiamethoxam 250 μg | 179.5 |
| AI/seed (and other polymers, biological components) | |
| Thiamethoxam 250 μg AI/seed (and other polymers, | 173.3 |
| biological components) | |

In addition, chlorantraniliprole 250 μg AI/seed+thiamethoxam 250 μg also resulted in better protection against wireworms at the seedling stage as evidenced by lower runts. Chlorantraniliprole 250 μg AI/seed+thiamethoxam 250 μg AI/seed resulted in 8.0% runts vs 8.8% for thiamethoxam 250 μg alone, which was statistically significant.

### Example 2: Efficacy of Chlorantraniliprole Against White Grub and Impact on Corn Yield

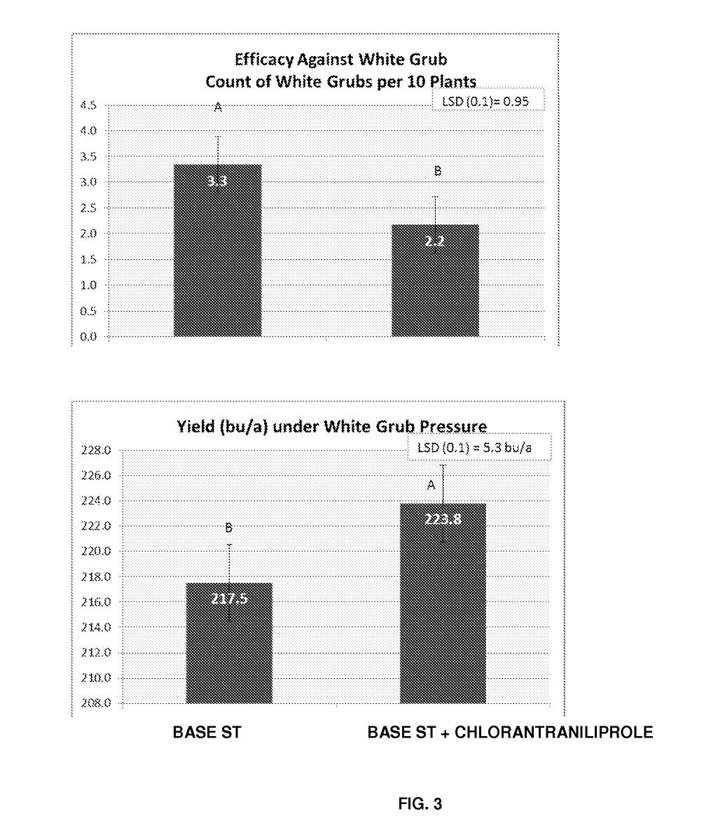

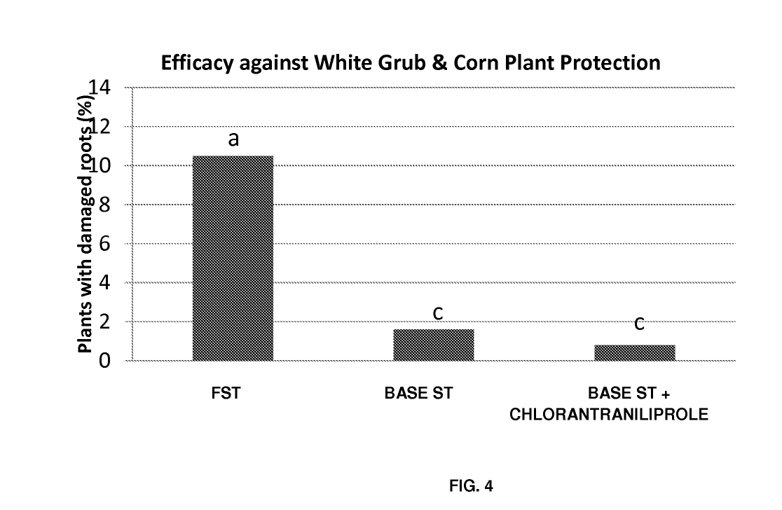

Efficacy of chlorantraniliprole against white grub (30 DAP) and impact on corn yield based on data from 3 locations was tested (FIG. 3). FIG. 4 shows efficacy of chlorantraniliprole against white grub (Japanese Beetle larvae), 28 days after planting.

The addition of chlorantraniliprole to the BASE ST significantly reduced white grub count per 10 plants resulting in increased grain yield compared to the BASE ST alone. Both BASE ST and BASE ST plus chlorantraniliprole significantly reduced damage to roots from white grub compared to FST alone. However, BASE ST plus chlorantraniliprole had the lowest numerical damage to roots of the seed treatments evaluated in this trial.

### Example 3: Efficacy of Chlorantraniliprole Against High Pressure of Black Cutworms, and Plant Stand Protection

The black cutworm is a destructive species of the cutworm family that affects corn. Moths generally migrate to the corn belt from coastal areas in early spring and eggs are deposited on early season weeds. Small young larvae chew holes in leaves and then, third stage or older larvae begin cutting plants at V1-V5 stage. Drilling into V6-V8 stage plants by the growing larvae can kill growing point. One larva can cut 3-4 plants before molting. Cutting occurs mostly above ground in wet soil and mostly below ground in dry soil. Wilted or dead plants can be observed due to tunneling of larger plants by older instars. Crops planted in reduced tillage or no-till fields, fields with soybean stubble, poorly drained areas, fields with early spring weed cover, and late-planted fields in cool, wet growing conditions are most likely to get infested by the black cutworms.

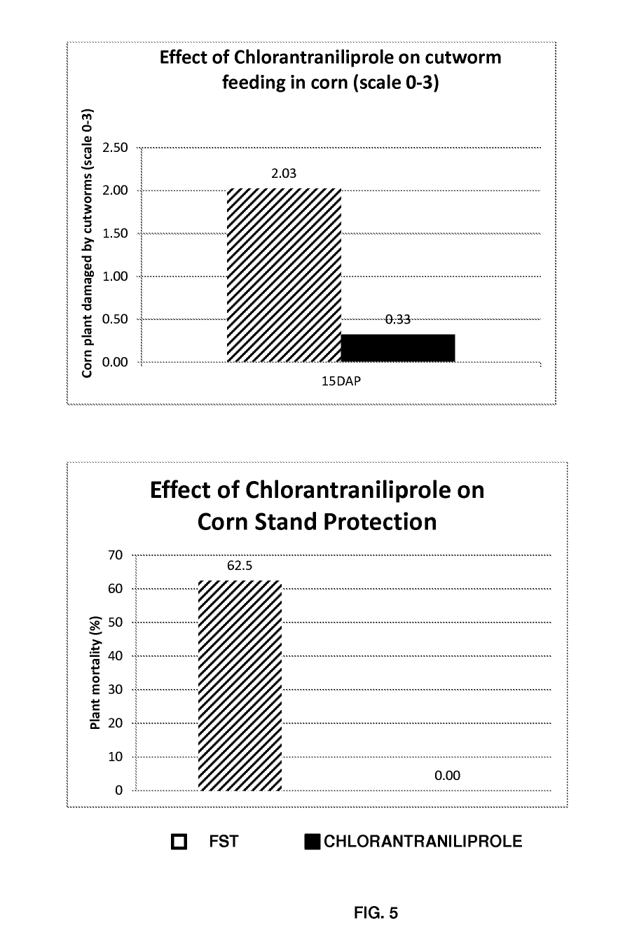

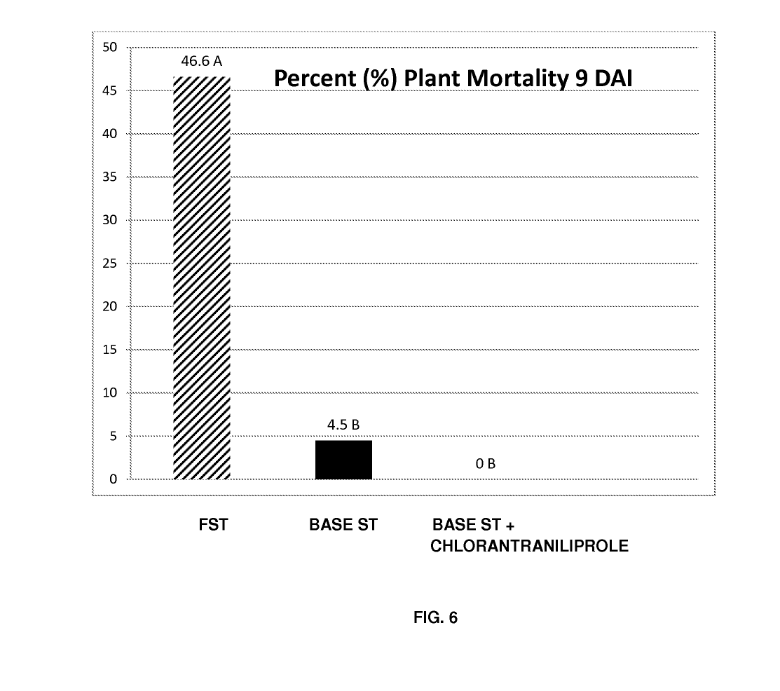

Efficacy of chlorantraniliprole against high pressure of black cutworms, and plant stand protection (15 DAP) was tested (FIG. 5). In addition, efficacy of chlorantraniliprole for healthier stand and longer seedling protection against black cutworms (9 DAI) was also tested (FIG. 6). See also Tables 3 and 4 for increased mortality rates of cutworms with chlorantraniliprole alone and in combination with other insecticides. Mortality of 3rd instar black cutworms, which were exposed to corn leaf samples in in-vivo leaf feeding bioassays, was recorded at specific evaluation dates. The leaf samples were collected from treated corn seed according to the treatment in Tables 3-4.

All treatments included a combination of fungicides (Fludioxonil, Mefenoxam, Azoxystrobin, Thiabendazole). Soil Texture was fine clay loam; insect species: Agrotis ipsilon; infestation: 2, 3rd instar larva/plant; Plot size: 6 rows×20 feet; Seeding rate: 39,000/acre; Experimental design: Randomized Complete Block (RCB); 9 trtms×4 rep.

Chlorantraniliprole significantly reduced black cutworm damage to corn plants resulting in a 62% reduction in plant mortality compared to FST alone. Chlorantraniliprole also increased healthier stand and longer seedling protection against black cutworms (9 DAI) (FIG. 6).

### Example 4: Efficacy of Chlorantraniliprole Against Seed Corn Maggot

Efficacy of chlorantraniliprole against seed corn maggot, 20 DAP was tested. Stand count per 25′ row was measured.

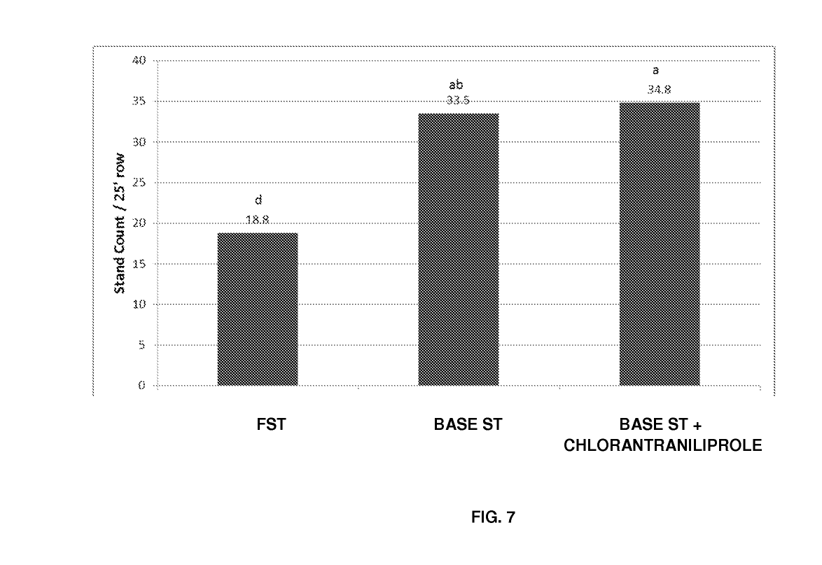

Both BASE ST and BASE ST plus chlorantraniliprole significantly increased stand compared to FST alone (FIG. 7). However, BASE ST plus chlorantraniliprole had the highest numerical stand of the seed treatments evaluated in this trial.

### Example 5: Efficacy of Chlorantraniliprole Against Fall Armyworm

Efficacy of chlorantraniliprole against fall armyworm was tested. BASE ST plus chlorantraniliprole significantly increased protection against early season fall armyworm compared to FST alone.

### Example 6: Efficacy of Chlorantraniliprole for Yield Improvement

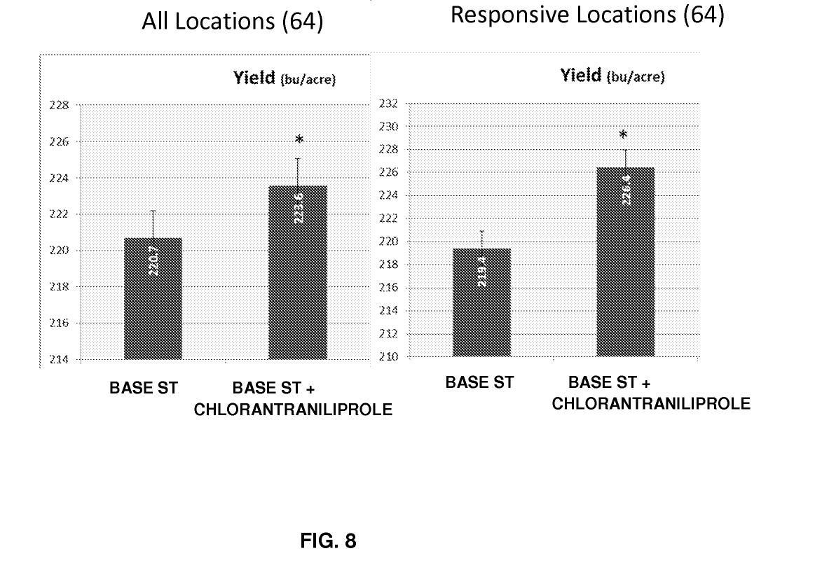

Yield impact of chlorantraniliprole was measured in a several locations. FIG. 8 shows yield impact of for corn treated with chlorantraniliprole based on all tested locations (total=64) and those locations with insect pressure (responsive locations=33) in the trial. In one of the trials, BASE ST plus chlorantraniliprole had a 2.9 bu/a advantage (67% of the locs) over BASE ST alone. In responsive locations (50/75 locs) for one of the trials, BASE ST plus chlorantraniliprole had 7.2 bu/a yield advantage over the BASE ST alone.

### Example 7: Method of Reducing Dust from Seeds Coated with Seed Treatments Including Chlorantraniliprole or Cyantraniliprole

Seed planters may release dust during the planting of seeds. One of the factors that can contribute to dust is seed coating used for planting. Other factors include for example, planting mechanism employed during seed planting. Planter lubricants, such as talc and graphite, are used to provide lubrication for seed flow through the planter. Planter lubrication, if not effective, may give rise to dust during planting. The resulting dust may contain one or more of the active ingredients that were used in the coating process. Chlorantraniliprole or cyantraniliprole containing compositions may be combined with one or more such lubricants or polymers or seed coating agents to reduce dust-off during planting. For example, in an embodiment, Chlorantraniliprole or cyantraniliprole containing compositions may be combined with a wax selected from the group consisting of polyethylene wax, carnuba wax, paraffin wax, polypropylene wax, and oxidized polyethylene wax.

In an embodiment, the disclosure provides a method of reducing dust containing chlorantraniliprole or cyantraniliprole released during planting of treated seeds by a planter. In an aspect, the disclosure provides for a method of improving seed flow by applying or treating seed containing chlorantraniliprole or cyantraniliprole with a dust-reducing agent. The dust-reducing agent can be applied to wet seed to increase seed lubricity. The disclosure also provides for a method reducing seed abrasion or seed attrition that may result in the formation of particulate matter such as dust from the surface of the treated seed during seed planting or other seed handling conditions.

### Example 8: Method of Pest Control with Reduced Application Rates of Neonicotinoid Insecticides as Seed Treatments

Chlorantraniliprole or cyantraniliprole mode of action is different than those of neonicotinoids such as e.g., The neonicotinoid family includes acetamiprid, clothianidin, imidacloprid, nitenpyram, nithiazine, thiacloprid and thiamethoxam. Therefore, chlorantraniliprole or cyantraniliprole, either alone or a combination thereof can be used in conjunction with a reduced rate of neonicotinoid insecticides without a substantial reduction in efficacy against one or more target pests in one or more crops such as for example, corn, soybean, wheat, sorghum, rice, and oil seeds such as canola.

For example, if the labeled rate for thiamethoxam is about 0.25-1.25 mg a.i./kernel for corn, then, in combination with chlorantraniliprole at a rate of about 0.25-0.750 mg a.i./kernel, the rate of thiamethoxam can be reduced by e.g., 25%, 50%, to about 75%. In one aspect, reduction of the use of neonicotinoids as insecticides can range from about 10%, 20%, 30%, 40%, 50%, 60%, 70%, 80% or 90% when used as seed treatment in combination with chlorantraniliprole or cyantraniliprole or a combination of chlorantraniliprole and cyantraniliprole. In an aspect, the combined use of one or more neonicotinoids, can be reduced by about 25% to about 50% by complementing with anthranilamide insecticides such as chlorantraniliprole or cyantraniliprole.

For example, if the labeled rate for clothianidin is about 0.25-1.25 mg a.i./kernel for corn, then, in combination with chlorantraniliprole at a rate of about 0.25-0.750 mg a.i./kernel, the rate of clothianidin can be reduced by e.g., 25%, or 50% to about 75%.

For example, if the labeled rate for imidacloprid is about 0.25, 0.6, 0.16-1.34 mg a.i./kernel for corn, then, in combination with chlorantraniliprole at a rate of about 0.25-0.750 mg a.i./kernel, the rate of imidacloprid can be reduced by e.g., 25%, or 50% to about 75%.

1. A seed treated with a seed treatment composition comprising an effective amount of chlorantraniliprole in combination with an insecticide thiamethoxam or clothianidin; a fungicide selected from the group consisting of azoxystrobin, fludioxonil, mefenoxam, thiabendazole, tebuconazol, prothioconazole, picoxystrobin, penthiopyrad, and oxathiapiprolin; and a seed treatment component selected from the group consisting of Bacillus firmus I-1582, Bacillus subtilis, Penicillium bilaii and Bacillus simplex.

2. The seed of claim 1 is a maize seed.

3. The seed of claim 1 is a maize seed comprising a recombinant nucleotide sequence encoding an insecticidal protein selected from the group consisting of Cry1Ab, Cry1F, Cry34/35, Vip3A, mCry3A, cry2A.127, cry1A.88, and Vip3Aa20.

4. The seed of claim 1 comprising an event DP-004114-3.

5. The seed of claim 1 comprising a non-transgenic trait providing tolerance to one or more pests or disease or drought.

6. The seed of claim 1 comprising a recombinant nucleotide expressing a dsRNA capable of downregulating an essential endogenous gene of a pest.

7. A seed treated with a seed treatment composition comprising an effective amount of cyantraniliprole in combination with an insecticide thiamethoxam, clothianidin or imidacloprid, a fungicide selected from the group consisting of metalaxyl, trifloxystrobin, penthiopyrad, oxathiapiprolin, sedaxane, penflufen, prothioconazole, difenoconazole, and fluopyram; and a seed treatment component selected from the group consisting of Bradyrhizobium japonicum, Bacillus firmus I-1582, Bacillus subtilis, Bacillus simplex, and Pasteuria nishizawae.

8. The seed of claim 7 is a soybean seed.

9. The seed of claim 7 is a soybean seed comprising a recombinant nucleotide sequence encoding an insecticidal protein.

10. The seed of claim 7 comprising a transgenic trait.

11. The seed of claim 7 comprising a non-transgenic trait providing tolerance to one or more pests or disease.

12. The seed of claim 11, wherein the non-transgenic trait provides tolerance to one or more of sudden death syndrome (SDS), soybean cyst nematode (SCN), phytophthora, and pythium.

13. (canceled)

14. A method of reducing wireworm and cutworm damage to plants, the method comprising growing a plant seed treated with chlorantraniliprole in combination with an insecticide thiamethoxam or clothianidin; a fungicide selected from the group consisting of azoxystrobin, fludioxonil, mefenoxam, thiabendazole, tebuconazol, prothioconazole, picoxystrobin, penthiopyrad, and oxathiapiprolin; and a seed treatment component selected from the group consisting of Bacillus firmus I-1582, Bacillus subtilis, Penicillium bilaii, and Bacillus simplex.

15. The method of claim 14, wherein the plant is grown in a crop growing environment suspected of containing wireworms.

16. (canceled)

17. (canceled)

18. A method of reducing insect damage to plants the method comprising:
(a) growing a plant seed treated with a reduced amount of one or more neonicotinoid insecticides and in combination with an effective amount of chlorantraniliprole; and
(b) reducing the extent of insect damage on the plants.

19. The method of claim 18, wherein amount of neonicotinoid insecticide is reduced by about 10%, 20%, 30%, 40%, 50%, 60%, 70%, 80% or 90% than the amount typically required to reduce the extent of damage to the plants.

20. (canceled)

21. (canceled)

22. The seed of claim 1 further comprising a dust-reducing agent applied to the surface of the seed.

23. The seed of claim 1 further comprising a dust-reducing agent applied during planting.

24. (canceled)

25. The method of claim 18, wherein the neonicotinoid seed treatment is selected from the group consisting of thiamethoxam, clothianidin, and imidacloprid.

26. The method of claim 18, wherein the plant seed is corn or soybeans.
